(19) United States
(12) Patent Application Publication
(10) Pub. No.: US 2024/0319340 A1
(43) Pub. Date: Sep. 26, 2024

(54) SINGLE PHOTON DETECTION DEVICE, SINGLE PHOTON DETECTOR, AND ELECTRONIC DEVICE

(71) Applicant: TRUPIXEL INC., Daejeon (KR)

(72) Inventor: Myung-Jae LEE, Seoul (KR)

(21) Appl. No.: 18/731,151

(22) Filed: May 31, 2024

Related U.S. Application Data
(63) Continuation-in-part of application No. 18/308,202, filed on Apr. 27, 2023.
(63) Continuation-in-part of application No. 18/307,790, filed on Apr. 26, 2023.
(63) Continuation-in-part of application No. 17/699,042, filed on Mar. 18, 2022.

(30) Foreign Application Priority Data
Aug. 31, 2021 (KR) 10-2021-0115811
Oct. 15, 2021 (KR) 10-2021-0137638
Aug. 24, 2022 (KR) 10-2022-0106211
Oct. 6, 2022 (KR) 10-2022-0127848

(51) Int. Cl. G01S 7/481; G01S 17/08

(52) U.S. Cl. CPC G01S 7/4816; G01S 17/08

(57) ABSTRACT

Disclosed is a single photon detection device comprises a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.

### CROSS-REFERENCE TO RELATED APPLICATIONS

This application is a continuation-in-part application of U.S. patent application Ser. No. 18/308,202, filed Apr. 27, 2023, which claims benefits of priority of Korean Patent Application No. 10-2022-0106211, filed Aug. 24, 2022, U.S. patent application Ser. No. 18/307,790, filed Apr. 26, 2023, which claims benefits of priority of Korean Patent Application No. 10-2022-0127848, filed Oct. 6, 2022, and U.S. patent application Ser. No. 17/699,042, filed Mar. 18, 2022, which claims benefits of priority of Korean Patent Application No. 10-2021-0115811, filed Aug. 31, 2021 and Korean Patent Application No. 10-2021-0137638, filed Oct. 15, 2021.

### BACKGROUND

Embodiments of the present disclosure described herein relate to single photon detection device, single photon detector, and electronic device.

The Avalanche Photodiode (APD) is a solid-stage light detector in which a high bias voltage is applied to the PN conjugation to provide a high first step gain from Avalanche Multiplication. When a photon with enough energy to release the electron reaches the photo diode, an electron-hole pair (EHP) is generated. The high electric field accelerates the photo-generated electrons quickly to (+) side, and the additional electrons-hole pairs are generated in succession by the impact ionization by such acceleration electrons. And then the electrons accelerate to the anode. Similarly, the holes are accelerated quickly toward (−) side and causes the same phenomenon. This process repeats the process leading to the Avalanche of the output current pulse and light generation electrons. Thus, APD is a semiconductor-based device that operates similarly to photomultiplier tubes. The linear mode APD is an effective amplifier that can control the bias voltage to set a gain and obtain tens of to thousands of gains in linear mode.

Single Photon Avalanche Diode (SPAD) is an APD in which the P-N bonding part is biased more than breakdown voltage to operate in the GEIGER mode. SPAD can generate a very large current, and as a result, a pulse signal that can be easily measured with a quenching resistor (or quenching circuit) can be obtained. That is, the SPAD operates as a device that generates a large pulse signal compared to the linear mode APD. After the triggering the Avalanche, the quenching resistance or the quenching circuit is used to reduce the bias voltage under the breakdown voltage for quenching the Avalanche process. Once the Avalanche Process is quenched, the bias voltage is rising back over the breakdown voltage so that the SPAD is reset for the detection of another photon. The above process can be referred to as re-biasing of SPAD.

SPAD can be configured with quenching resistance or circuit, recharge circuits, memory, gate circuits, counter, and time-digital converter. SPAD pixels are semiconductor-based, so it can be easily arrayed.

APD or SPAD may have a defect according to the manufacturing process. A defect in APD or SPAD can produce electrons. For example, electrons can be generated by defects according to the formation of the Shallow Trench Isolation (STI). The electrons generated by defects can be increased in a depletion region (or a multiplication region) in the APD or SPAD. As a result, noise signals may occur. In addition, the electrons generated by defects can be the cause of the after pulse phenomenon in which Avalanche occurs even though the photon is not incident on the APD or SPAD. If after pulse phenomenon is expected to occur, it may be necessary to increase the dead time, which is a preparation time for the APD or SPAD to detect one photon and the next photon, to prevent the impact. In some example embodiments, when the APD or SPAD operation, the frame rate or signal-to-noise ratio (SNR) may be reduced.

### SUMMARY

Embodiments of the present disclosure provide a single photon detection device, single photon detector, and electronic device having improved light detection efficiency, fill factor, and power consumption characteristics.

According to example embodiments, a single photon detection device comprises a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.

In some embodiments, the single photon detection device further comprises a first well provided on the bottom surface of the heavily doped region and having the first conductivity type. The first well extends to a region vertically overlapping with the guard ring and the contact region.

In some embodiments, the depletion region extends along a boundary between the heavily doped region and the guard ring and a boundary between the heavily doped region and the first well.

In some embodiments, the single photon detection device further comprises a second well provided between the heavily doped region and the first well and having the first conductivity type. The depletion region extends along a boundary between the heavily doped region and the guard ring and a boundary between the heavily doped region and the second well.

In some embodiments, the guard ring extends to a depth deeper than the second well.

In some embodiments, the guard ring extends to a depth deeper than the second well.

In some embodiments, the second well extends to a depth deeper than the guard ring.

In some embodiments, a side surface of the heavily doped region and a side surface of the second well are vertically aligned.

In some embodiments, the single photon detection device further comprises a third well provided between the heavily doped region and the first well and having the second conductivity type. The depletion region extends along a boundary between the third well and the guard ring and a boundary between the third well and the first well.

In some embodiments, the third well extends between the heavily doped region and the guard ring to cover the side surface of the heavily doped region.

In some embodiments, the single photon detection device further comprises a first sub-depletion forming region provided on an opposite side of the first well with respect to the heavily doped region and having the first conductivity type, and a first sub-depletion region provided between the heavily doped region and the first sub-depletion forming region.

In some embodiments, the single photon detection device further comprises a second sub-depletion forming region provided on an opposite side of the heavily doped region with respect to the first well and having the second conductivity type, and a second sub-depletion region provided between the first well and the second sub-depletion forming region.

In some embodiments, the single photon detection device further comprises a relief region provided on a bottom surface of the contact region and having the first conductivity type. A doping concentration of the relief region is lower than a doping concentration of the contact region.

In some embodiments, the single photon detection device further comprises a first well provided on the bottom surface of the heavily doped region and having the first conductivity type. The first well extends between the guard ring and the relaxation region.

In some embodiments, the relaxation region is in contact with the guard ring.

In some embodiments, a side surface of the contact region and a side surface of the relief region form a coplanar surface.

In some embodiments, the single photon detection device further comprises an insulating pattern provided on a side surface of the heavily doped region and in contact with the guard ring.

In some embodiments, the single photon detection device further comprises a third well provided between the heavily doped region and the first well, extending between the heavily doped region and the guard ring, and having the second conductivity type. The insulating pattern is in contact with the third well.

According to example embodiments, a single photon detector comprises a single photon detection device, a connection layer, and a lens layer that delivers incident light to the single photon detection device. The single photon detection device comprises a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.

According to example embodiments, an electronic device comprises a light emitting device and a single photon detection device detecting incident light reflected from an object upon which light emitted from the light emitting device is incident, the electronic device measuring a distance to the object using time difference information between a transmission signal of the light emitting device and a detection signal of the single photon detection device, The single photon detection device comprises a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.

### BRIEF DESCRIPTION OF THE FIGURES

The above and other objects and features of the present disclosure will become apparent by describing in detail embodiments thereof with reference to the accompanying drawings.

FIG. 1 is a plan view of a single photon detection device according to example embodiments.

FIG. 2 is a cross-sectional view of the single photon detection device of FIG. 1 taken along line A-A′.

FIG. 3 is a plan view of the single photon detection device of FIG. 2 according to example embodiments.

FIG. 4 is a plan view of the single photon detection device of FIG. 2 according to example embodiments.

FIG. 5 is a plan view of the single photon detection device of FIG. 2 according to example embodiments.

FIG. 6 is a plan view of the single photon detection device of FIG. 2 according to example embodiments.

FIG. 7 is a plan view of the single photon detection device of FIG. 2 according to example embodiments.

FIG. 8 is a plan view of the single photon detection device of FIG. 2 according to example embodiments.

FIG. 9 is a cross-sectional view corresponding to line A-A′ of the single photon detection device of FIG. 1.

FIG. 10 is a cross-sectional view corresponding to line A-A′ of the single photon detection device of FIG. 1.

FIG. 11 is a cross-sectional view corresponding to line A-A′ of the single photon detection device of FIG. 1.

FIG. 12 is a cross-sectional view corresponding to line A-A′ of the single photon detection device of FIG. 1.

FIG. 13 is a cross-sectional view corresponding to line A-A′ of the single photon detection device of FIG. 1.

FIG. 14 is a cross-sectional view corresponding to line A-A′ of the single photon detection device of FIG. 1.

FIG. 15 is a cross-sectional view corresponding to line A-A′ of the single photon detection device of FIG. 1.

FIG. 16 is a cross-sectional view corresponding to line A-A′ of the single photon detection device of FIG. 1.

FIG. 17 is a plan view of a single photon detection device according to example embodiments.

FIG. 18 is a cross-sectional view corresponding to line B-B′ of the single photon detection device of FIG. 17.

FIG. 19 is a plan view of a single photon detection device according to example embodiments.

FIG. 20 is a cross-sectional view corresponding to line C-C′ of the single photon detection device of FIG. 19.

FIG. 21 is a plan view of a single photon detection device according to example embodiments.

FIG. 22 is a cross-sectional view corresponding to line D-D′ of the single photon detection device of FIG. 21.

FIG. 23 is a plan view of a single photon detection device according to example embodiments.

FIG. 24 is a cross-sectional view corresponding to the line E-E′ of the single photon detection device of FIG. 23.

FIG. 25 is a plan view of a single photon detection device according to example embodiments.

FIG. 26 is a cross-sectional view corresponding to line F-F′ of the single photon detection device of FIG. 25.

FIG. 27 is a cross-sectional view corresponding to line F-F′ of the single photon detection device of FIG. 25.

FIG. 28 is a plan view of a single photon detection device according to example embodiments.

FIG. 29 is a cross-sectional view corresponding to the line G-G′ of the single photon detection device of FIG. 28.

FIG. 30 is a cross-sectional view of a single photon detection device according to example embodiments.

FIGS. 31, 32, and 33 are cross-sectional views corresponding to the C-C′ line of FIG. 19.

FIGS. 34, 35, 36, 37, 38, 39, 40, 41, 42, 43, 44, 45, 46, and 47 are cross-sectional views corresponding to the A-A′ line of FIG. 1.

FIGS. 48 and 49 are cross-sectional views corresponding to the B-B′ line of FIG. 17.

FIG. 50A is a plan view of a single photon detection device according to example embodiments.

FIG. 50B is a cross-sectional view along the J1-J1′ line of FIG. 50A.

FIGS. 51 and 52 are cross-sectional views corresponding to the J1-J1′ line of FIG. 50A.

FIG. 53A is a plan view of a single photon detection device according to example embodiments.

FIG. 53B is a cross-sectional view along the J2-J2′ line of FIG. 53A.

FIGS. 54, 55, 56, 57, 58, 59, 60, 61, 62, 63, 64, 65, and 66 are cross-sectional views corresponding to the J2-J2′ line of FIG. 53A.

FIG. 67A is a plan view of a single photon detection device according to example embodiments.

FIG. 67B is a cross-sectional view along the J3-J3′ line of FIG. 67A.

FIG. 68 is a cross-sectional view corresponding to the J3-J3′ line of FIG. 67A.

FIG. 69 is a cross-sectional view corresponding to the G-G′ line of FIG. 28.

FIG. 70A is a plan view of a single photon detection device according to example embodiments.

FIG. 70B is a cross-sectional view along the J4-J4′ line of FIG. 70A.

FIG. 71A is a plan view of a single photon detection device according to example embodiments.

FIG. 71B is a cross-sectional view along the J5-J5′ line of FIG. 71A.

FIG. 71C is a cross-sectional view corresponding to the J5-J5′ line of FIG. 71A.

FIG. 72A is a plan view of a single photon detection device according to example embodiments.

FIG. 72B is a cross-sectional view along the J6-J6′ line of FIG. 72A.

FIG. 72C is a cross-sectional view corresponding to the J6-J6′ line of FIG. 72A.

FIG. 73 is a cross-sectional view of a single photon detector according to example embodiments.

FIG. 74 is a cross-sectional view of a single photon detector according to example embodiments.

FIG. 75 is a cross-sectional view of a single photon detector according to example embodiments.

FIG. 76 is a plan view of a single photon detector array according to example embodiments.

FIGS. 77, 78, and 79 are cross-sectional views along the H-H′ line of FIG. 34.

FIG. 80 is a block diagram for explaining an electronic device according to example embodiments.

FIGS. 81 and 82 are conceptual diagrams showing the application of a LiDAR device to a vehicle according to example embodiments.

### DETAILED DESCRIPTION

Hereinafter, with reference to the accompanying drawings, the embodiments of the present disclosure will be described in detail. In the following drawings, the same reference code refers to the same component, and the size of each component in the drawings may be exaggerated for the clarity and convenience of the description. On the other hand, the embodiments described below are only an example, and various variations are possible from these embodiments.

Hereinafter, what is described as “on” may include not only being directly on contact but also being on non-contact.

Singular expressions include plural expressions unless the context clearly dictates otherwise. In addition, when a certain component is said to “include”, this means that it may further include other components without excluding other components unless otherwise stated.

In addition, terms such as “unit” or “part” described in the specification mean a unit that processes at least one function or operation.

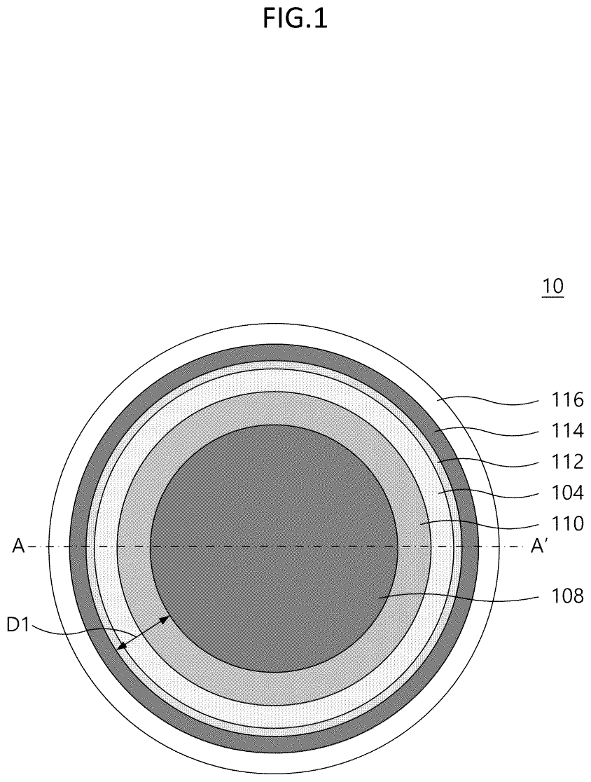

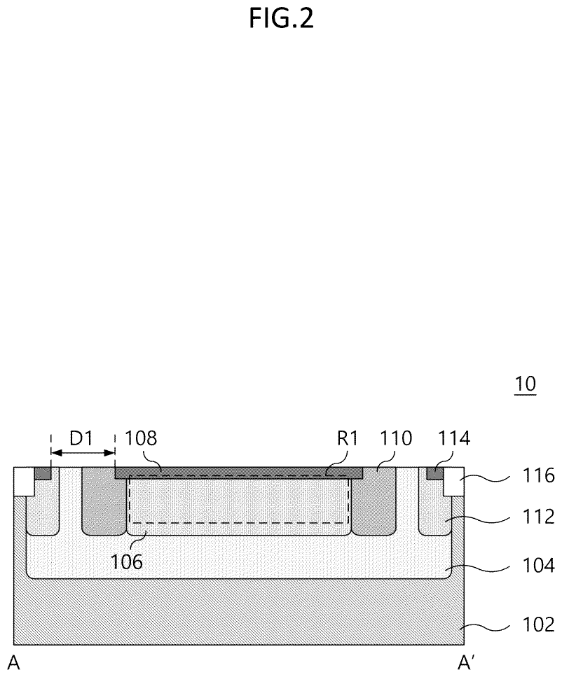

FIG. 1 is a plan view of a single photon detection device according to example embodiments. FIG. 2 is a cross-sectional view of the single photon detection device of FIG. 1 taken along line A-A′.

Referring to FIGS. 1 and 2, a single photon detection device 10 may be provided. The single photon detection device 10 may be a single photon avalanche diode (SPAD). A single photon avalanche diode (SPAD) may be referred to as a Geiger-mode avalanche diode (G-APD). The single photon detection device 10 may include a substrate region 102, a first well 104, a second well 106, a heavily doped region 108, a guard ring 110, a relief region 112, a contact 114, and an isolation region 116. The first well 104, the second well 106, the heavily doped region 108, the guard ring 110, the relief region 112, and the contact 114 are formed on a semiconductor substrate (eg, silicon (Si) substrate), which may be formed by implanting impurities. The isolation region 116 may be formed by, for example, a process of filling an insulating material in a recess region formed by etching a semiconductor substrate. The isolation region 116 may be shallow trench isolation (STI). In one example, in a CMOS process of approximately 180 nm to 250 nm or less, shallow trench isolation (STI) is automatically generated between adjacent active regions, and the isolation region 116 may be STI. The substrate region 102 may be the rest of the semiconductor substrate except for the first well 104, the second well 106, a heavily doped region 108, a guard ring 110, a relief region 112, the contact 114, and the isolation region 116.

The substrate region 102 may include silicon (Si), germanium (Ge), or silicon germanium (SiGe). The conductivity type of the substrate region 102 may be n-type or p-type. When the conductivity type of the substrate region 102 is n-type, the substrate region 102 may include a group 5 element (eg, phosphorus (P), arsenic (As), antimony (Sb), etc.), group 6 or group 7 element as an impurity. Hereinafter, a region having an n-type conductivity may include a group 5, 6, or 7 element as an impurity. When the conductivity type of the substrate region 102 is p-type, the substrate region 102 may include a group 3 element (eg, boron (B), aluminum (Al), gallium (Ga), indium (In), etc.) or 2 Group elements as impurities. Hereinafter, a region having a p-type conductivity may include a group 3 or group 2 element as an impurity. For example, the doping concentration of the substrate region 102 may be 1×10¹⁴ to 1×10¹⁹ cm⁻³. The semiconductor substrate may be an epi layer formed by an epitaxial growth process.

The first well 104 may be provided on the substrate region 102. The first well 104 may directly contact with the substrate region 102. The first well 104 may have a first conductivity type. For example, the conductivity type of the first well 104 may be n-type or p-type. For example, the doping concentration of the first well 104 may be 1×10¹⁴ to 1×10¹⁹ cm⁻³. In one example, the doping concentration of the first well 104 can vary continuously within the first well 104. For example, the doping concentration of the first well 104 may decrease as it is closer to the top surface of the single photon detection device 10. In one example, the first well 104 may have a uniform doping concentration. Although the top surface of the first well 104 is shown to be disposed to substantially the same height as the top surface of the single photon detection device 10, this is not limiting. In another example, the top surface of the first well 104 may be below the top surface of the single photon detection device 10 (e.g., at a height between the top surface of the single photon detection device 10 and the bottom surface of the second well 106) can be placed.

The second well 106 may be provided on the first well 104. The second well 106 may directly contact with the first well 104. The second well 106 may have a first conductivity type. In one example, the doping concentration of the second well 106 may be uniform. In one example, the doping concentration of the second well 106 can vary continuously within the second well 106. For example, the doping concentration of the second well 106 may be 1×10¹⁴ to 1×10¹⁹ cm⁻³. The doping concentration may vary discontinuously at the boundary between the first well 104 and the second well 106.

A heavily doped region 108 may be provided on the second well 106. The heavily doped region 108 may be provided on the top surface of the second well 106. The heavily doped region 108 may contact the second well 106. A width of the heavily doped region 108 may be greater than that of the second well 106. The width of the heavily doped region 108 and the second well 106 may be the size of the heavily doped region 108 and the second well 106 along a direction parallel to the top surface of the substrate. An end portion of the heavily doped region 108 may protrude from side surfaces of the second well 106. The heavily doped region 108 may be exposed between guard rings 110 to be described below. The heavily doped region 108 may have a second conductivity type different from the first conductivity type. For example, the doping concentration of the heavily doped region 108 may be 1×10¹⁵ to 1×10²² cm⁻³. When the single photon detection device 10 is a single photon avalanche diode (SPAD), the heavily doped region 108 may be electrically connected to at least one of a quenching resistor (or quenching circuit) and other pixel circuits. A quenching resistor or quenching circuit may be configured to stop the avalanche effect and allow the single photon avalanche diode (SPAD) to detect another photon. Other pixel circuits may include, for example, reset or recharge circuits, memories, amplifier circuits, counters, gate circuits, time-to-digital converters, and the like. Other pixel circuits may transmit signals to the single photon detection device 10 or receive signals from the single photon detection device 10. In one example, the heavily doped region 108 may be electrically connected to an external power source or an integrated power source (eg, DC-to-DC converter, a charge pump, a boost converter, and other power management integrated circuits).

A depletion region R1 may be formed in a region adjacent to an interface between the second well 106 and the heavily doped region 108. The size of the depletion region R1 is shown as an example, and is not limited. When a reverse bias is applied to the single photon detection device 10, a strong electric field may be formed in the depletion region R1. For example, when the single photon detection device 10 operates as a single photon avalanche diode (SPAD), the maximum magnitude of the electric field may be about 1×10⁵ to 1×106 V/cm. Since electrons may be multiplied by the electric field of the depletion region R1, the depletion region R1 may be referred to as a multiplication region.

The guard ring 110 may be provided on side surfaces of the heavily doped region 108 and side surfaces of the second well 106. The guard ring 110 may surround the heavily doped region 108 and the second well 106. For example, the guard ring 110 may have a ring shape extending along the side surfaces of the heavily doped region 108 and the side surfaces of the second well 106. The guard ring 110 may directly contact with the heavily doped region 108 and the second well 106. In another example, the guard ring 110 may be apart from the heavily doped region 108 and the second well 106. An top surface of the guard ring 110 may be disposed at substantially the same height as an top surface of the heavily doped region 108. The bottom surface of the guard ring 110 may be disposed at substantially the same height as the bottom surface of the second well 106. The guard ring 110 may have a second conductivity type. The doping concentration of the guard ring 110 may be lower than that of the heavily doped region 108. For example, the doping concentration of the guard ring 110 may be 1×10¹⁵ to 1×10¹⁸ cm⁻³. The guard ring 110 may improve breakdown characteristics of the single photon detection device 10. In detail, the guard ring 110 may relieve concentration of an electric field at the edge of the heavily doped region 108 to prevent premature breakdown. The early breakdown phenomenon is a breakdown phenomenon that occurs at the corner of the heavily doped region 108 before an electric field having sufficient magnitude is applied to the depletion region R1. The early breakdown phenomenon occurs as the electric field is concentrated at the corner of the highly doped region 108.

The contact 114 may be provided on the first well 104. The contact 114 may be electrically connected to a circuit outside the single photon detection device 10. When the single photon detection device 10 is a single photon avalanche diode (SPAD), the contact 114 may be electrically connected to at least one of an external power supply and an integrated power source (eg, DC-to-DC converter, a charge pump, a boost converter, and other power management integrated circuits). In one example, contact 114 may be electrically connected to at least one of a quenching resistor (or quenching circuit) and other pixel circuitry. A quench resistor or quench circuit may stop the avalanche effect and allow the single photon avalanche diode (SPAD) to detect another photon. Other pixel circuits may include, for example, reset or recharge circuits, memories, amplifier circuits, counters, gate circuits, time-to-digital converters, and the like. Other pixel circuits may transmit signals to the single photon detection device 10 or receive signals from the single photon detection device 10. The contact 114 may be provided on the opposite side of the heavily doped regions 108 with the guard ring 110 interposed therebetween. The contact 114 may surround the guard ring 110. In another example, a plurality of contacts 114 may be provided. In some example embodiments, the plurality of contacts 114 may be electrically connected to an external circuit of the single photon detection device 10, respectively. The contact 114 may have a first conductivity type. A doping concentration of the contact 114 may be higher than that of the first well 104. For example, the doping concentration of the contact 114 may be 1×10¹⁵ to 1×1022 cm⁻³.

A relief region 112 may be provided between the contact 114 and the first well 104. The relief region 112 may be electrically connected to the contact 114 and the first well 104. The relief region 112 may relieve a difference in doping concentration between the contact 114 and the first well 104. The relief region 112 may improve electrical connection characteristics between the contact 114 and the first well 104. For example, the relief region 112 is configured to reduce or prevent a voltage drop when a voltage is applied to the first well 104 through the contact 114 and to uniformly apply the voltage to the first well 104. Relief region 112 may extend along contact 114. The relief region 112 may be provided on side and bottom surfaces of the contact 114. For example, the relief region 112 may directly contact side and bottom surfaces of the contact 114. The relief region 112 may surround the guard ring 110. The relief region 112 may be apart from the guard ring 110. The first well 104 may extend to a region between the relief region 112 and the guard ring 110. For example, a region between the relief region 112 and the guard ring 110 may be filled with the first well 104. In one example, a region between the relief region 112 and the guard ring 110 may be filled with the substrate region 102 and the first well 104. The relief region 112 may be formed to the same depth as the bottom surface of the guard ring 110. In another example, the relief region 112 may be formed to a depth deeper than or shallower than the bottom surface of the guard ring 110. The relief region 112 may have a first conductivity type. The doping concentration of the relief region 112 may be lower than that of the contact 114 and may be similar to or higher than the doping concentration of the first well 104. For example, the doping concentration of the relief region 112 may be 1×10¹⁵ to 1×10¹⁹ cm⁻³.

When several active regions (eg, p+ region and n+ region) are formed during semiconductor device design, Shallow Trench Isolation (STI) is automatically generated between adjacent active regions in a CMOS process of approximately 180 nm to 250 nm or less. For example, STI between the contact 114 and the heavily doped region 108 may be automatically generated. STI can often create defects in substrates. The defects generated by STI between the contact 114 and the heavily doped region 108 may cause a dark count rate and an after pulse phenomenon. The present disclosure may provide the single photon detection device 10 configured such that no STI is intentionally formed between the contact 114 and the heavily doped region 108. Accordingly, noise and after pulse phenomena may be reduced or prevented. Accordingly, dead time, which is a preparation time for the APD or SPAD to detect the next photon after detecting one photon, can be reduced. When designing a semiconductor device, by intentionally forming an active layer between the p+ region and the n+ region, STI may not be intentionally formed between the contact 114 and the heavily doped region 108. In one example, the distance DI between the contact 114 and the heavily doped region 108 may be 0.2 μm to 2.5 μm. In one example, the operation is possible even if the distance DI between the contact 114 and the heavily doped region 108 is further increased, but there is a limit since the fill factor of the device may decrease. When the distance DI between the contact 114 and the heavily doped region 108 is less than 0.2 μm to 2.5 μm, leakage current may occur.

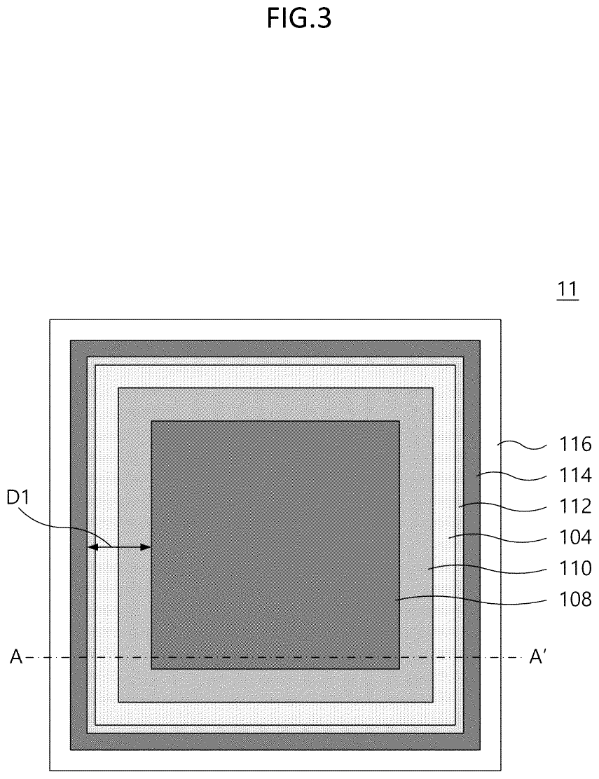

FIG. 3 is a plan view of the single photon detection device of FIG. 2 according to example embodiments. Differences from those shown in FIG. 1 are described for brevity of explanation.

Referring to FIG. 3, a single photon detection device 11 may be provided. Unlike that shown in FIG. 1, the single photon detection device 11 may have a square shape. Specifically, the heavily doped region 108 may have a square shape, and the guard ring 110, the first well 104, the relief region 112, the contact 114, and the isolation region 116 may have a square ring shape surrounding the heavily doped region 108. The guard ring 110, the first well 104, the relief region 112, the contact 114, and the isolation region 116 may be sequentially arranged in a direction away from the heavily doped region 108. For example, the guard ring 110, the first well 104, the relief region 112, the contact 114, and the isolation region 116 may have the same center.

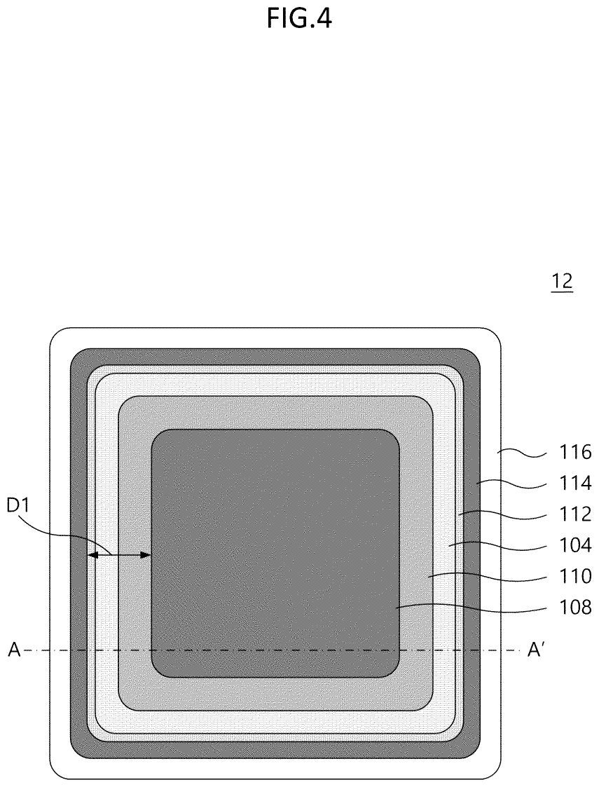

FIG. 4 is a plan view of the single photon detection device of FIG. 2 according to example embodiments. Differences from those shown in FIG. 1 are described for brevity of explanation.

Referring to FIG. 4, a single photon detection device 12 may be provided. Unlike that shown in FIG. 1, the single photon detection device 12 may have a square shape with rounded corners. Specifically, the heavily doped region 108 may have a square shape with rounded corners, and the guard ring 110, the first well 104, the relief region 112, the contact 114, and the isolation region 116 may have a square ring shape with rounded corners surrounding the heavily doped region 108. The guard ring 110, the first well 104, the relief region 112, the contact 114, and the isolation region 116 may be sequentially arranged in a direction away from the heavily doped region 108. For example, the heavily doped region 108, the guard ring 110, the first well 104, the relief region 112, the contact 114, and the isolation region 116 may have the same center.

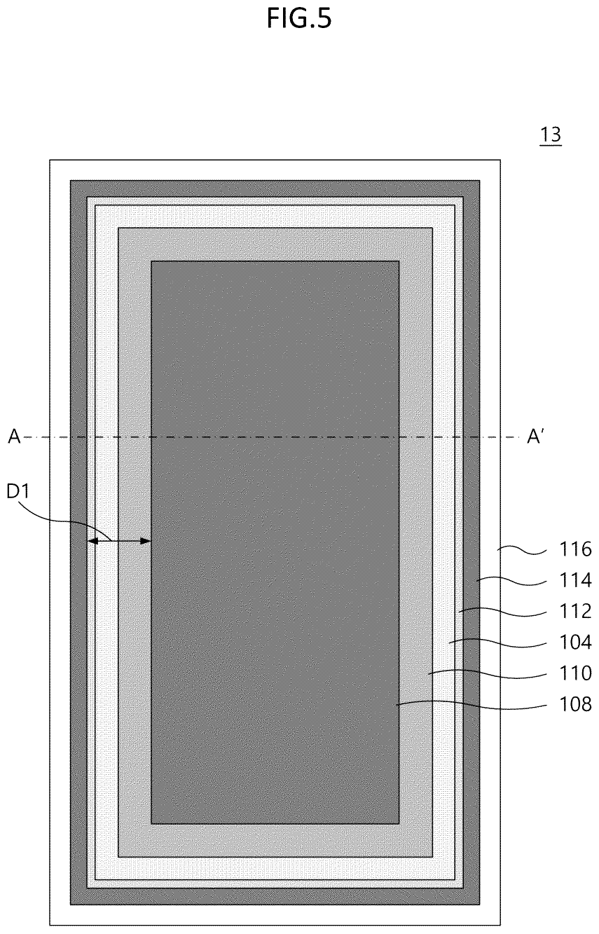

FIG. 5 is a plan view of the single photon detection device of FIG. 2 according to example embodiments. Differences from those shown in FIG. 1 are described for brevity of explanation.

Referring to FIG. 5, a single photon detection device 13 may be provided. Unlike that shown in FIG. 1, the single photon detection device 13 may have a rectangular shape. Specifically, the heavily doped region 108 may have a rectangular shape, and the guard ring 110, the first well 104, the relief region 112, the contact 114, and the isolation region 116 may have a rectangular ring shape surrounding the heavily doped region 108. The guard ring 110, the first well 104, the relief region 112, the contact 114, and the isolation region 116 may be sequentially arranged in a direction away from the heavily doped region 108. For example, the heavily doped region 108, the guard ring 110, the first well 104, the relief region 112, the contact 114, and the isolation region 116 may have the same center.

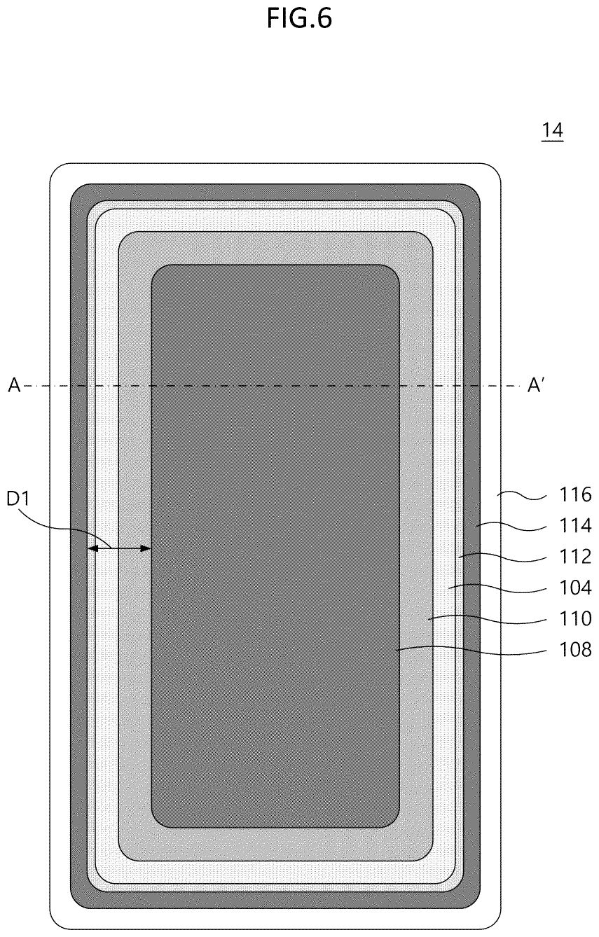

FIG. 6 is a plan view of the single photon detection device of FIG. 2 according to example embodiments. Differences from those shown in FIG. 1 are described for brevity of explanation.

Referring to FIG. 6, a single photon detection device 14 may be provided. Unlike that shown in FIG. 1, the single photon detection device 14 may have a rectangular shape with rounded corners. Specifically, the heavily doped region 108 may have a rectangular shape with rounded corners, and the guard ring 110, the first well 104, the relief region 112, the contact 114, and the isolation region 116 may have a rectangular ring shape with rounded corners surrounding the heavily doped region 108. The guard ring 110, the first well 104, the relief region 112, the contact 114, and the isolation region 116 may be sequentially arranged in a direction away from the heavily doped region 108. For example, the heavily doped region 108, the guard ring 110, the first well 104, the relief region 112, the contact 114, and the isolation region 116 may have the same center.

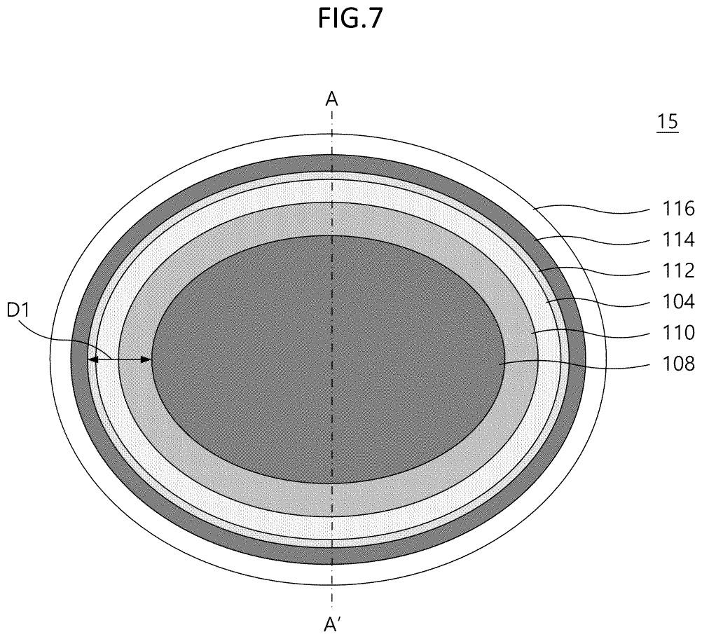

FIG. 7 is a plan view of the single photon detection device of FIG. 2 according to example embodiments. Differences from those shown in FIG. 1 are described for brevity of explanation.

Referring to FIG. 7, a single photon detection device 15 may be provided. Unlike that shown in FIG. 1, the single photon detection device 15 may have an elliptical shape. Specifically, the heavily doped region 108 may have an elliptical shape, and the guard ring 110, the relief region 112, the first well 104, the contact 114, and the isolation region 116 may have an elliptical ring shape surrounding the heavily doped region 108. The guard ring 110, the relief region 112, the first well 104, the contact 114, and the isolation region 116 may be sequentially arranged in a direction away from the heavily doped region 108. For example, the heavily doped region 108, the guard ring 110, the first well 104, the relief region 112, the contact 114, and the isolation region 116 may have the same center.

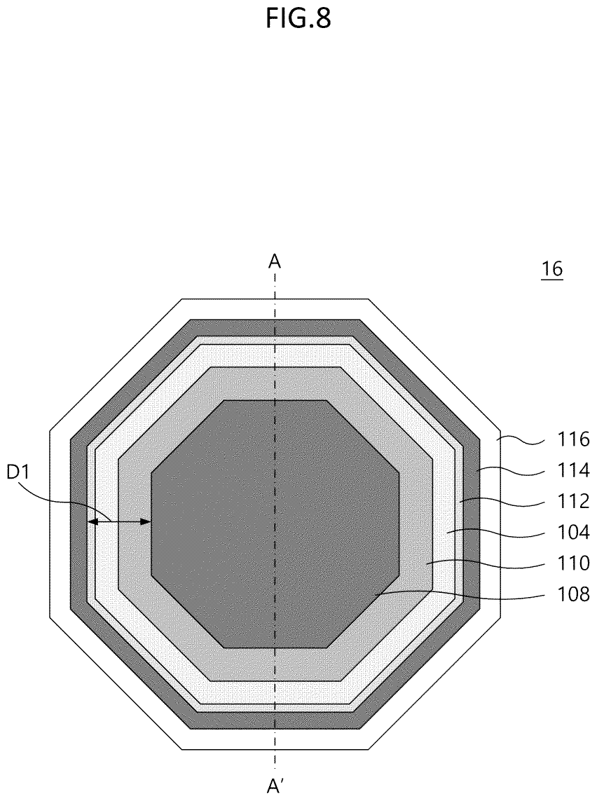

FIG. 8 is a plan view of the single photon detection device of FIG. 2 according to example embodiments. Differences from those shown in FIG. 1 are described for brevity of explanation.

Referring to FIG. 8, a single photon detection device 16 may be provided. Unlike that shown in FIG. 1, the single photon detection device 16 may have an octagonal shape. Specifically, the heavily doped region 108 may have an octagonal shape, and the guard ring 110, the relief region 112, the first well 104, the contact 114, and the isolation region 116 may have an octagonal ring shape surrounding the heavily doped region 108. The guard ring 110, the relief region 112, the first well 104, the contact 114, and the isolation region 116 may be sequentially arranged in a direction away from the heavily doped region 108. For example, the heavily doped region 108, the guard ring 110, the first well 104, the relief region 112, the contact 114, and the isolation region 116 may have the same center.

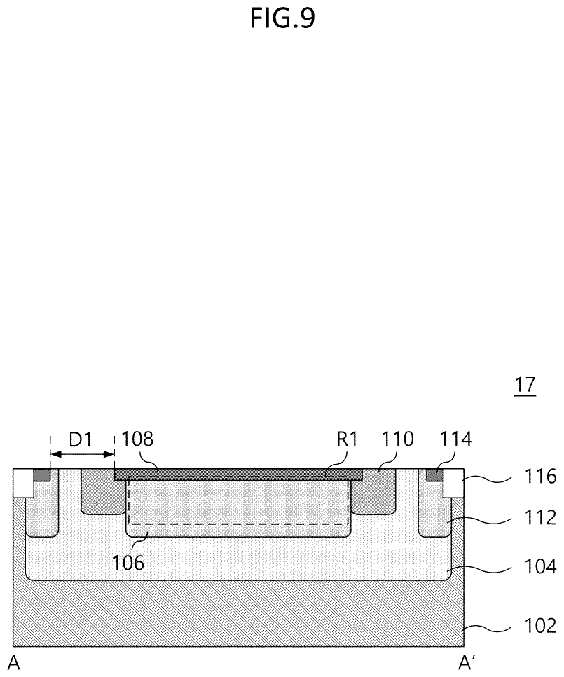

FIG. 9 is a cross-sectional view corresponding to line A-A′ of the single photon detection device of FIG. 1. Differences from those described with reference to FIGS. 1 and 2 are described for brevity of description.

Referring to FIG. 9, a single photon detection device 17 may be provided. Unlike the description with reference to FIGS. 1 and 2, the bottom surface of the guard ring 110 may be disposed at a height between the bottom surface and the top surface of the second well 106. The doping concentration of the guard ring 110 may be higher than that of the guard ring 110 described with reference to FIGS. 1 and 2. For example, the doping concentration of the guard ring 110 may be 1×10¹⁶ to 1×10¹⁸ cm⁻³.

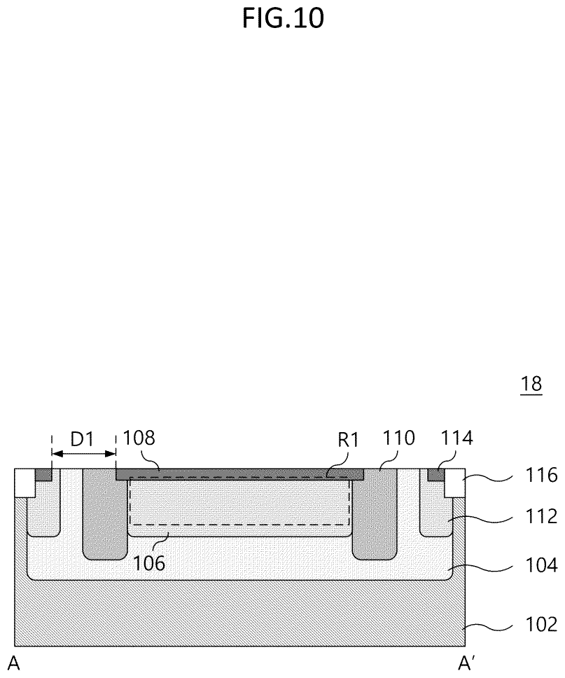

FIG. 10 is a cross-sectional view corresponding to line A-A′ of the single photon detection device of FIG. 1. Differences from those described with reference to FIGS. 1 and 2 are described for brevity of description.

Referring to FIG. 10, a single photon detection device 18 may be provided. Unlike the description with reference to FIGS. 1 and 2, the bottom surface of the second well 106 may be disposed at a height between the bottom surface and the top surface of the guard ring 110. The doping concentration of the guard ring 110 may be lower than that of the guard ring 110 described with reference to FIGS. 1 and 2. For example, the doping concentration of the guard ring 110 may be 1×10¹⁵ to 1×1017 cm⁻³.

In another example, unlike those described with reference to FIGS. 1 and 2, the second well 106 may have a second conductivity type. The doping concentration of the second well 106 may be lower than that of the heavily doped region 108 and higher than that of the guard ring 110. For example, the doping concentration of the second well 106 may be 1×10¹⁶ to 1×10¹⁸ cm⁻³. When the second well 106 has the second conductivity type, the depletion region R1 may be formed adjacent to the boundary between the second well 106 and the first well 104.

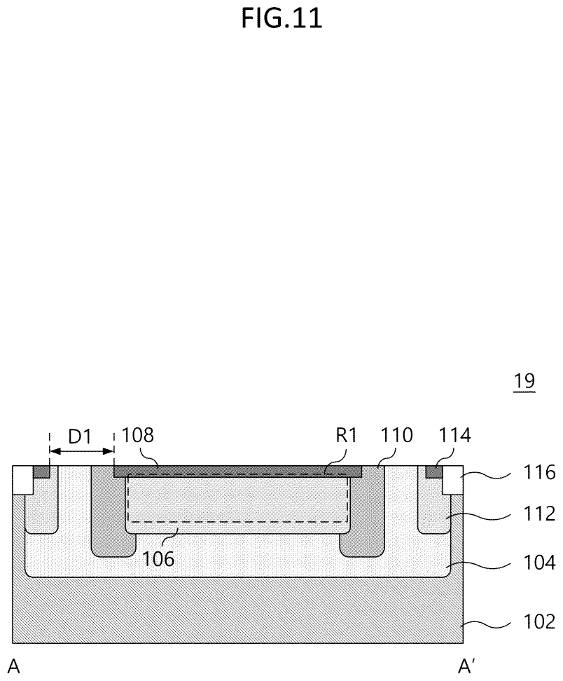

FIG. 11 is a cross-sectional view corresponding to line A-A′ of the single photon detection device of FIG. 1. Differences from those described with reference to FIGS. 1 and 2 are described for brevity of description.

Referring to FIG. 11, a single photon detection device 19 may be provided. Unlike those described with reference to FIGS. 1 and 2, the guard ring 110 may extend from a region on the side surface of the second well 106 to a region on the bottom surface of the second well 106. For example, the doping concentration of the guard ring 110 may be 1×10¹⁵ to 1×10¹⁸ cm⁻³.

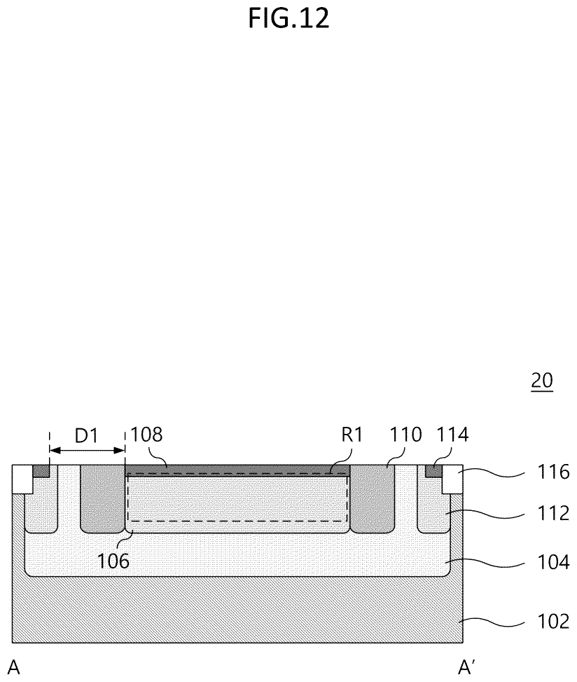

FIG. 12 is a cross-sectional view corresponding to line A-A′ of the single photon detection device of FIG. 1. Differences from those described with reference to FIGS. 1 and 2 are described for brevity of description.

Referring to FIG. 12, a single photon detection device 20 may be provided. Unlike the description with reference to FIGS. 1 and 2, a side surface of the heavily doped region 108 may be aligned with a side surface of the second well 106. A side surface of the heavily doped region 108 may be coplanar with a side surface of the second well 106. An end portion of the heavily doped region 108 may not protrude from a side surface of the second well 106.

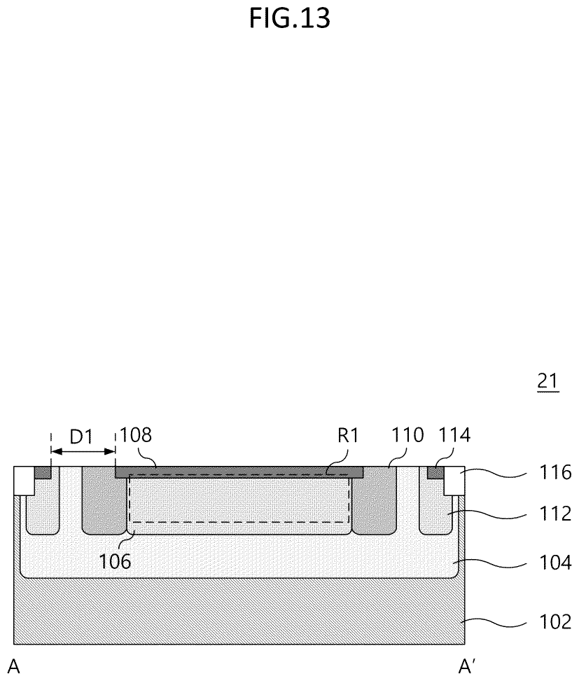

FIG. 13 is a cross-sectional view corresponding to line A-A′ of the single photon detection device of FIG. 1. Differences from those described with reference to FIGS. 1 and 2 are described for brevity of description.

Referring to FIG. 13, a single photon detection device 21 may be provided. Unlike those described with reference to FIGS. 1 and 2, the first well 104 may cover a side surface opposite to the side of the relief region 112 facing the guard ring 110 (hereinafter referred to as the outer surface of the relief region 112). The outer surface of the relief region 112 may be apart from the substrate region 102 with the first well 104 therebetween.

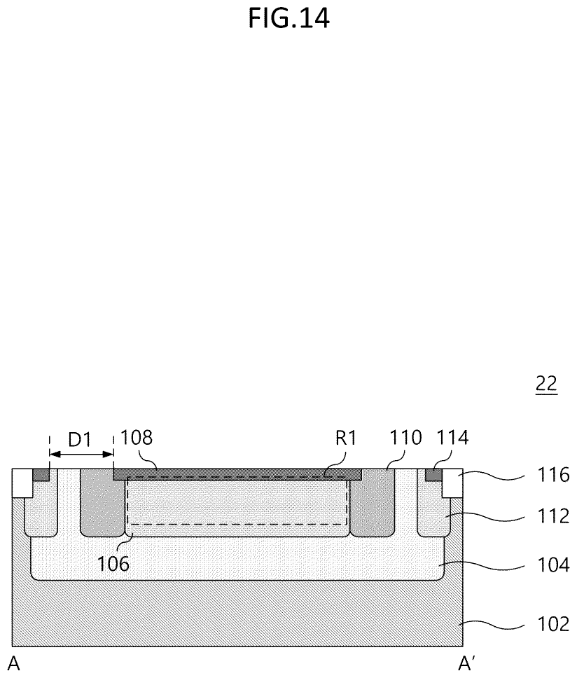

FIG. 14 is a cross-sectional view corresponding to line A-A′ of the single photon detection device of FIG. 1. Differences from those described with reference to FIGS. 1 and 2 are described for brevity of description.

Referring to FIG. 14, a single photon detection device 22 may be provided. Unlike the description with reference to FIGS. 1 and 2, the relief region 112 may protrude from the side of the first well 104. The substrate region 102 may cover an outer surface and a bottom surface of the relief region 112.

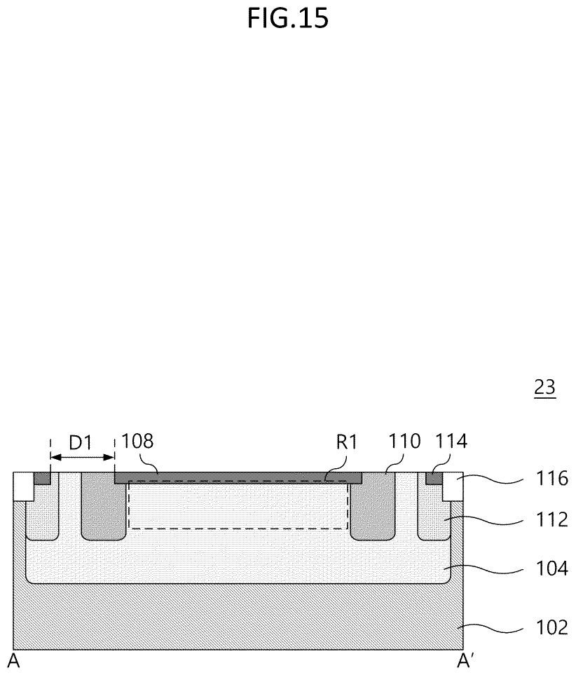

FIG. 15 is a cross-sectional view corresponding to line A-A′ of the single photon detection device of FIG. 1. Differences from those described with reference to FIGS. 1 and 2 are described for brevity of description.

Referring to FIG. 15, a single photon detection device 23 may be provided. Unlike the description with reference to FIGS. 1 and 2, the second well 106 is not provided between the heavily doped region 108 and the first well 104, and the first well 104 may directly contact with the heavily doped region 108.

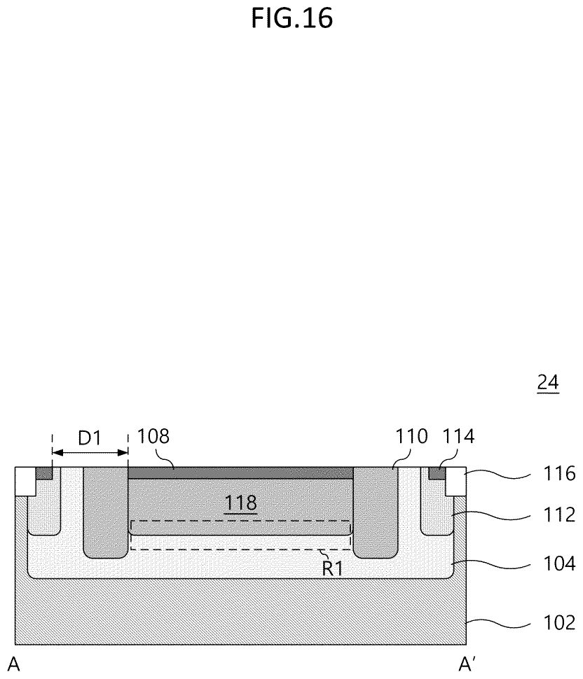

FIG. 16 is a cross-sectional view corresponding to line A-A′ of the single photon detection device of FIG. 1. Differences from those described with reference to FIGS. 1 and 2 are described for brevity of description.

Referring to FIG. 16, a single photon detection device 24 may be provided. Unlike the description with reference to FIGS. 1 and 2, a third well 118 may be provided between the first well 104 and the heavily doped region 108. The second well 106 may not be provided. The third well 118 may separate the heavily doped region 108 and the first well 104 from each other. The third well 118 may be provided on the bottom surface of the heavily doped region 108. A side surface of the third well 118 and a side surface of the heavily doped region 108 may be aligned. A side surface of the third well 118 and a side surface of the heavily doped region 108 may form a coplanar surface. The third well 118 may have the second conductivity type. The doping concentration of the third well 118 may be lower than that of the heavily doped region 108 and higher than that of the guard ring 110. For example, the doping concentration of the third well 118 may be 1×10¹⁶ to 1×10¹⁸ cm⁻³. The depletion region R1 may be formed adjacent to a boundary between the third well 118 and the first well 104.

The guard ring 110 may extend from the top surface of the single photon detection device 24 to a position deeper than the bottom surface of the third well 118. The bottom surface of the guard ring 110 may be disposed closer to the bottom surface of the first well 104 than the bottom surface of the third well 118. The guard ring 110 may have a smaller doping concentration than that of the third well 118. For example, the doping concentration of the guard ring 110 may be 1×10¹⁵ to 1×1017 cm⁻³.

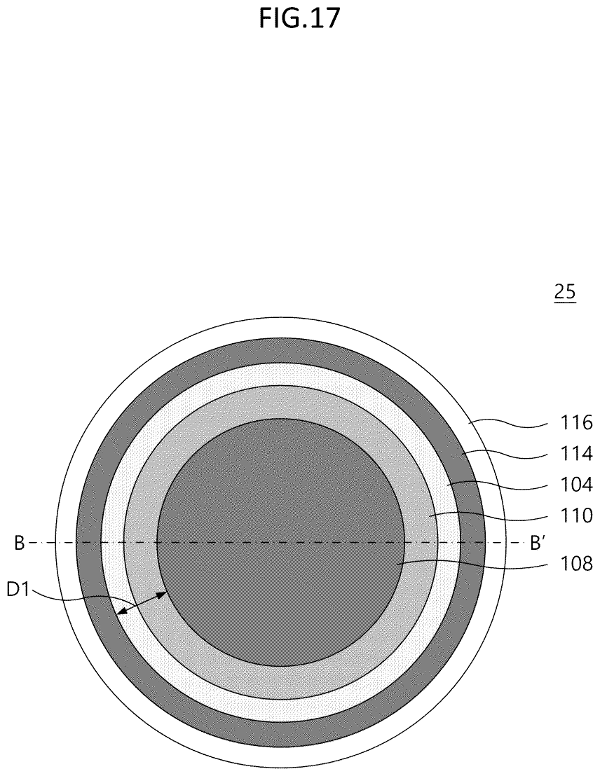

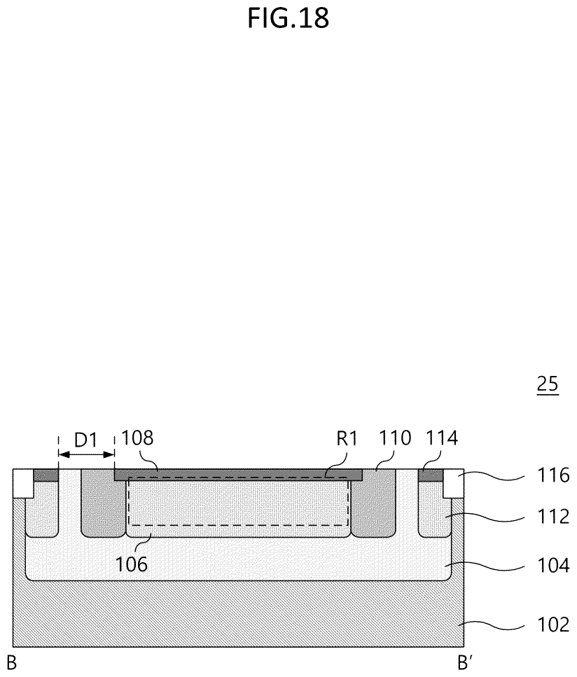

FIG. 17 is a plan view of a single photon detection device according to example embodiments. FIG. 18 is a cross-sectional view corresponding to line B-B′ of the single photon detection device of FIG. 17. Differences from those described with reference to FIGS. 1 and 2 are described for brevity of description.

Referring to FIGS. 17 and 18, a single photon detection device 25 may be provided. Unlike what has been described with reference to FIGS. 1 and 2, a side surface of the contact 114 may be aligned with a side surface of the relief region 112. In other words, the side surface of the contact 114 and the side surface of the relief region 112 may form a coplanar surface. The side surface of the contact 114 may directly contact with the first well 104 and the isolation region 116. A bottom surface of the contact 114 may directly contact with the relief region 112.

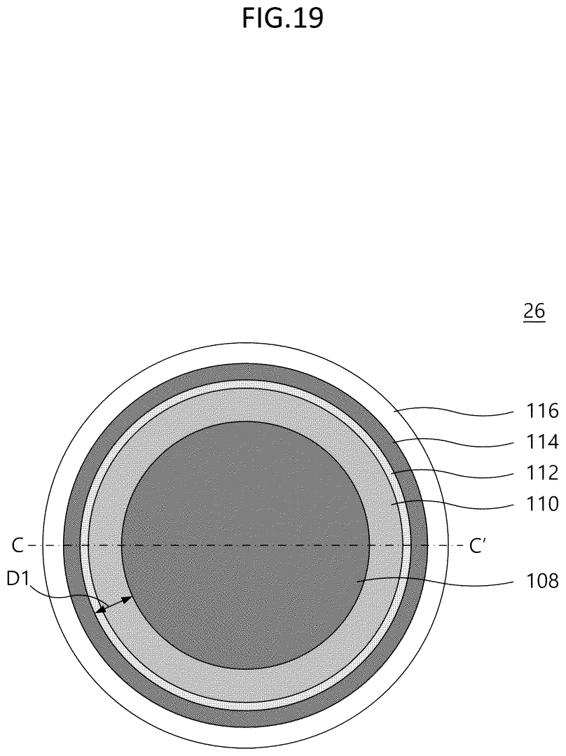

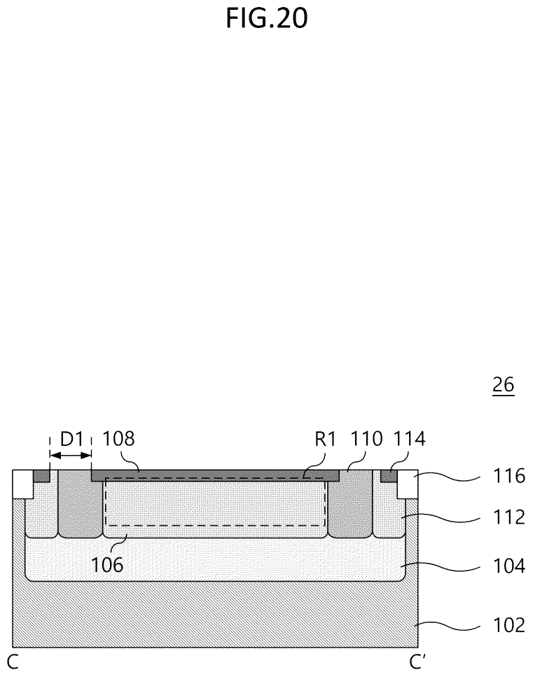

FIG. 19 is a plan view of a single photon detection device according to example embodiments. FIG. 20 is a cross-sectional view corresponding to line C-C′ of the single photon detection device of FIG. 19. Differences from those described with reference to FIGS. 1 and 2 are described for brevity of description.

Referring to FIGS. 19 and 20, a single photon detection device 26 may be provided. Unlike the description with reference to FIGS. 1 and 2, the guard ring 110 may directly contact with the relief region 112. For example, the guard ring 110 may fill a region between the relief region 112 and the second well 106 and a region between the relief region 112 and the heavily doped region 108. As shown in FIG. 9, when the bottom surface of the guard ring 110 is located at a height between the top surface and the bottom surface of the second well 106, the guard ring 110 may fill a portion of the region between the relief region 112 and the second well 106, and the first well 104 may fill another portion of the region between the relief region 112 and the second well 106.

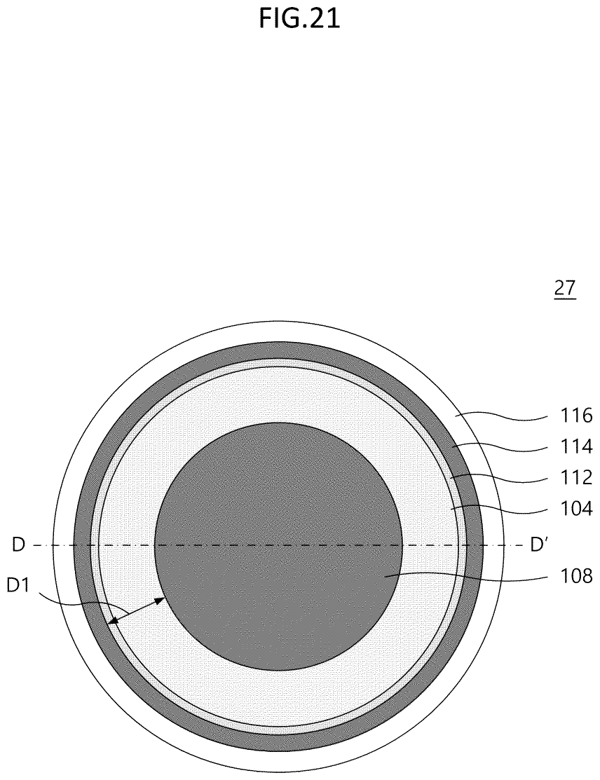

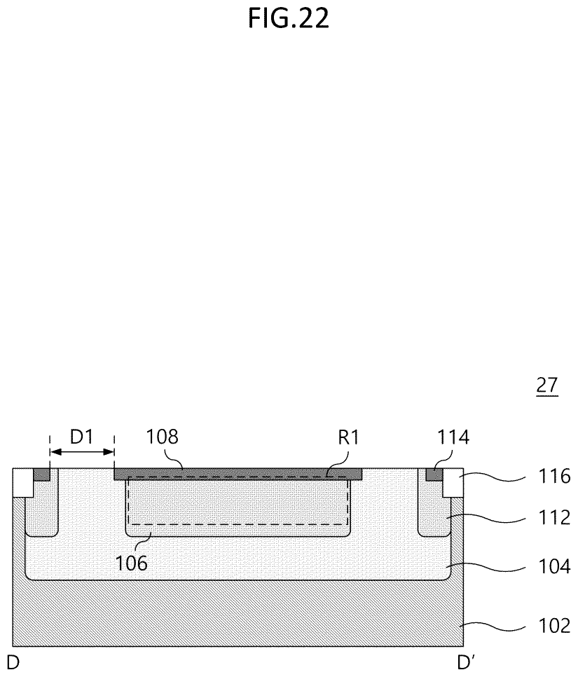

FIG. 21 is a plan view of a single photon detection device according to example embodiments. FIG. 22 is a cross-sectional view corresponding to line D-D′ of the single photon detection device of FIG. 21. Differences from those described with reference to FIGS. 1 and 2 are described for brevity of description.

Referring to FIGS. 21 and 22, a single photon detection device 27 may be provided. Unlike the description with reference to FIGS. 1 and 2, regions between the heavily doped region 108 and the relief region 112 and between the second well 106 and the relief region 112 may be filled with the first well 104. The heavily doped region 108 may directly contact with the first well 104. The guard ring 110 may not be provided.

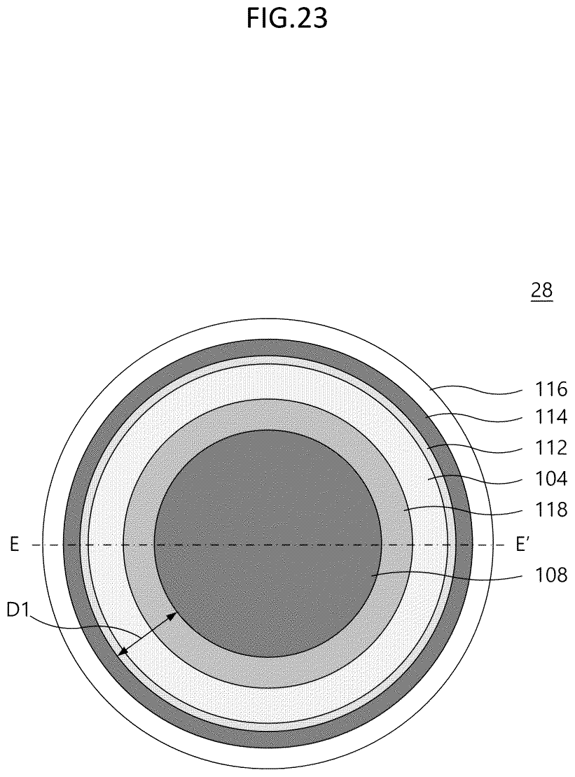

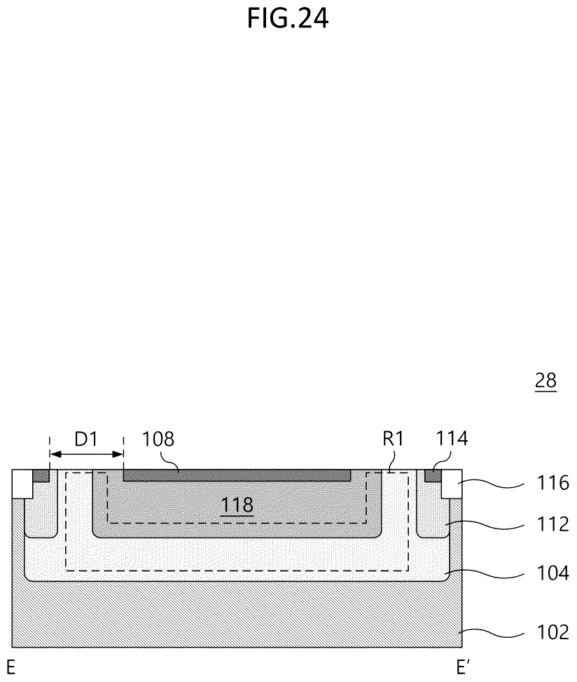

FIG. 23 is a plan view of a single photon detection device according to example embodiments. FIG. 24 is a cross-sectional view corresponding to the line E-E′ of the single photon detection device of FIG. 23. Differences from those described with reference to FIGS. 1 and 2 are described for brevity of description.

Referring to FIGS. 23 and 24, a single photon detection device 28 may be provided. Unlike the description with reference to FIGS. 1 and 2, a third well 118 may be provided between the first well 104 and the heavily doped region 108. The second well 106 and the guard ring 110 may not be provided. The third well 118 may separate the heavily doped region 108 and the first well 104 from each other. The third well 118 may have a second conductivity type. The doping concentration of the third well 118 may be lower than that of the heavily doped region 108. For example, the doping concentration of the third well 118 may be 1×10¹⁶ to 1×10¹⁸ cm⁻³. The depletion region R1 may be formed in a region adjacent to a boundary between the third well 118 and the first well 104.

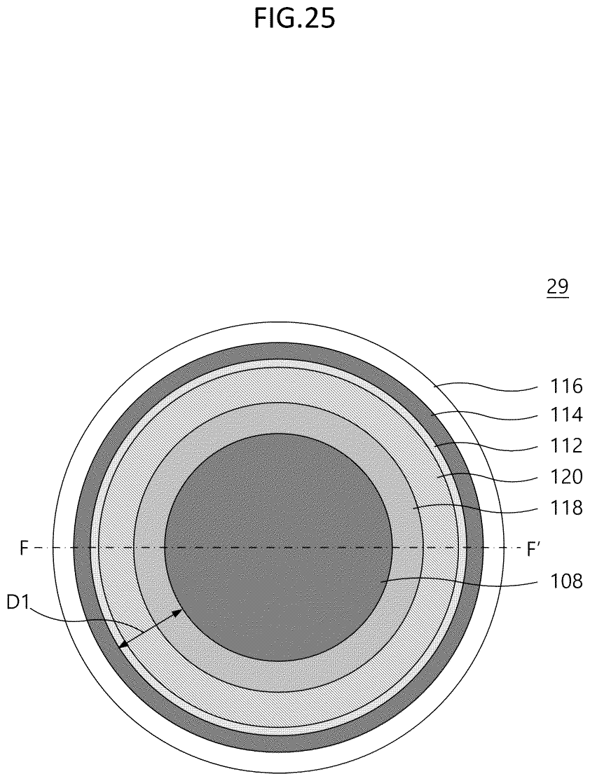

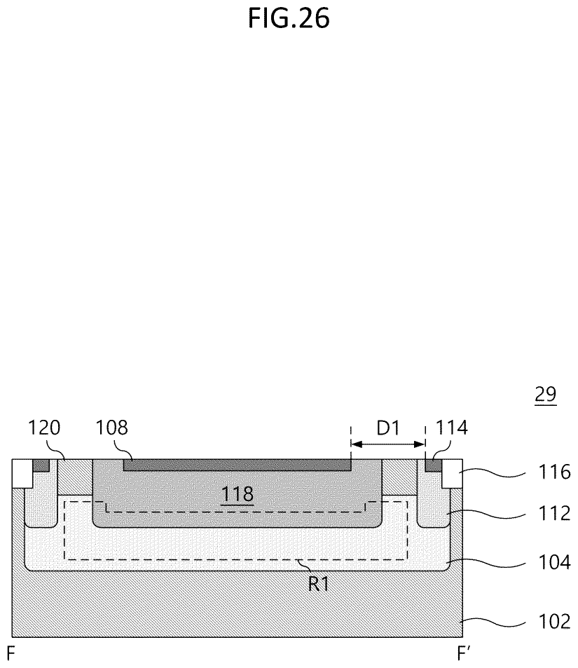

FIG. 25 is a plan view of a single photon detection device according to example embodiments. FIG. 26 is a cross-sectional view corresponding to line F-F′ of the single photon detection device of FIG. 25. For brevity of description, differences from those described with reference to FIGS. 23 and 24 are described.

Referring to FIGS. 25 and 26, a single photon detection device 29 may be provided. Unlike the description with reference to FIGS. 23 and 24, the sub-substrate region 120 may be provided between the relief region 112 and the third well 118. The sub-substrate region 120 may surround the third well 118. The sub-substrate region 120 may have the same conductivity type as the substrate region 102. The sub-substrate region 120 may have substantially the same doping concentration as the substrate region 102. For example, the doping concentration of the sub-substrate region 120 may be 1×10¹⁴ to 1×10¹⁸ cm⁻³. The sub-substrate region 120 may extend from the top surface of the single photon detection device 29 to a certain depth. For example, the bottom surface of the sub-substrate region 120 may be located at a height between the top surface and the bottom surface of the third well 118. In one example, the sub-substrate region 120 may be a region above the substrate region 102 where ions are not implanted in the ion implantation process for forming the first well 104 (ie, an upper portion of the substrate).

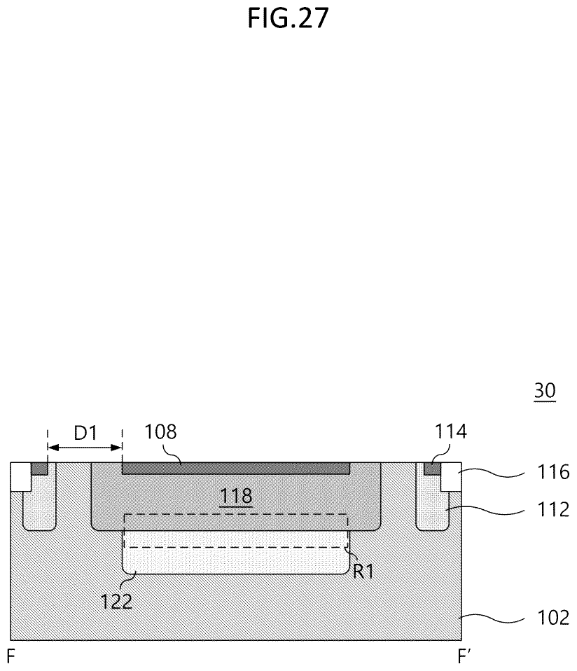

FIG. 27 is a cross-sectional view corresponding to line F-F′ of the single photon detection device of FIG. 25. For brevity of description, differences from those described with reference to FIGS. 25 and 26 are described.

Referring to FIG. 27, a single photon detection device 30 may be provided. Unlike the description with reference to FIGS. 25 and 26, a fourth well 122 may be provided instead of the first well 104. The fourth well 122 may be provided between the third well 118 and the substrate region 102. The fourth well 122 may directly contact with the third well 118 and the substrate region 102. The fourth well 122 may be provided on the bottom surface of the third well 118. For example, the width of the fourth well 122 may be smaller than that of the third well 118. The fourth well 122 may have the same conductivity type as the substrate region 102. A doping concentration of the fourth well 122 may be higher than that of the substrate region 102. For example, the doping concentration of the fourth well 122 may be 1×10¹⁶ to 1×10¹⁹ cm⁻³. The depletion region may be formed in a region adjacent to a boundary between the third well 118 and the fourth well 122.

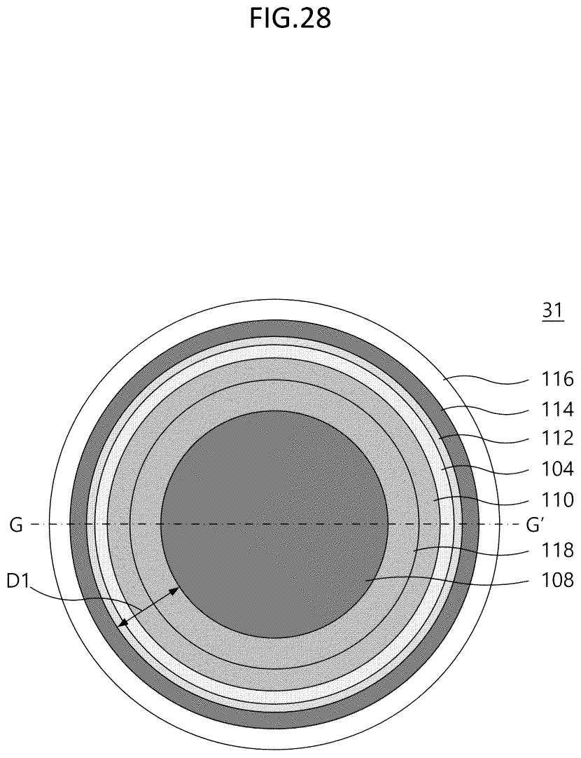

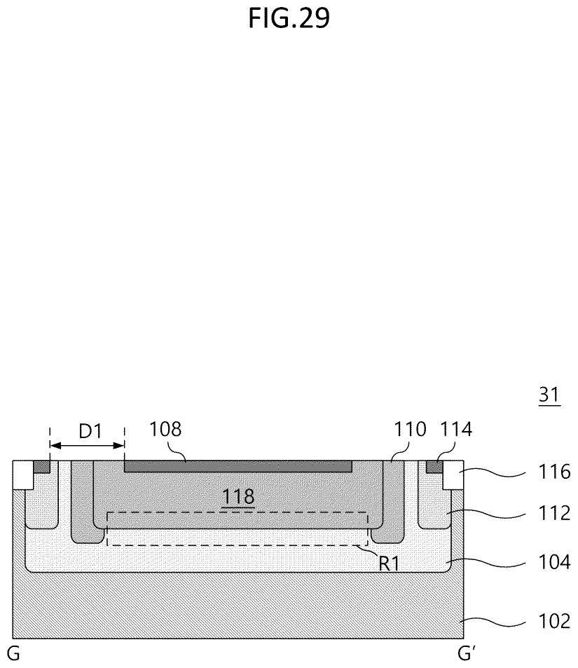

FIG. 28 is a plan view of a single photon detection device according to example embodiments. FIG. 29 is a cross-sectional view corresponding to the line G-G′ of the single photon detection device of FIG. 28. For brevity of description, differences from those described with reference to FIGS. 23 and 24 are described.

Referring to FIGS. 28 and 29, a single photon detection device 31 may be provided. Unlike the description with reference to FIGS. 23 and 24, the guard ring 110 may be provided on the side of the third well 118. The guard ring 110 may extend from a region on the side surface of the third well 118 to a region on the bottom surface of the third well 118. The bottom surface of the guard ring 110 may be located closer to the bottom surface of the first well 104 than the bottom surface of the third well 118. The guard ring 110 may have a second conductivity type. The guard ring 110 may have a smaller doping concentration than that of the third well 118. For example, the doping concentration of the guard ring 110 may be 1×10¹⁵ to 1×10¹⁸ cm⁻³.

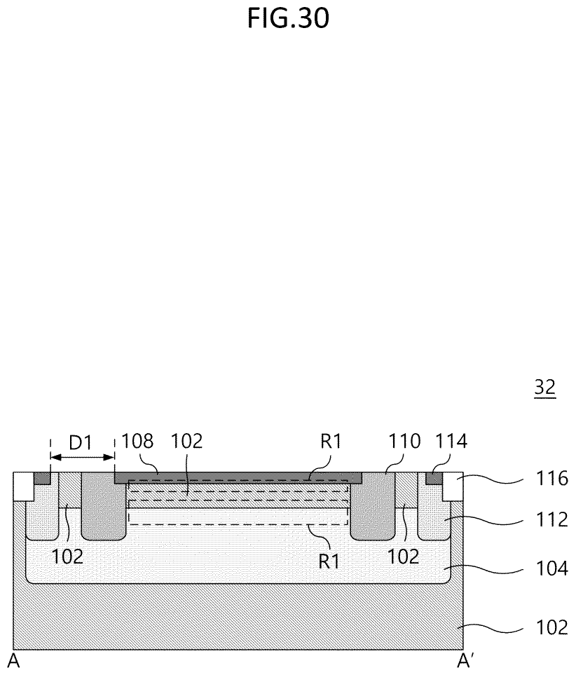

FIG. 30 is a cross-sectional view of a single photon detection device according to example embodiments. For brevity of description, content substantially the same as that described with reference to FIG. 15 may not be described.

Referring to FIG. 30, a single photon detection device 32 may be provided. Unlike the description with reference to FIG. 15, the first well 104 may be provided to be apart from the top surface of the substrate. The first well 104 may be provided to be apart from the heavily doped region 108. The top surface of the first well 104 may not directly contact with the heavily doped region 108. A substrate region 102 may be provided between the first well 104 and the heavily doped region 108. When the substrate region 102 has the same conductivity type as the heavily doped region 108 (ie, when the substrate region 102 has a second conductivity type), the depletion region R1 may be formed adjacent to the boundary between the substrate region 102 and the well 104. When the substrate region 102 has the same conductivity type as the first well 104 (ie, when the substrate region 102 has the first conductivity type), the depletion region R1 may be formed adjacent to the boundary between the substrate region 102 and the heavily doped region 108. When the substrate region 102 is an intrinsic semiconductor or is very lightly doped to approximate an intrinsic semiconductor, the depletion region R1 may be formed between the heavily doped region 108 and the first well 104.

A substrate region 102 may be provided on the first well 104 between the guard ring 110 and the relief region 112.

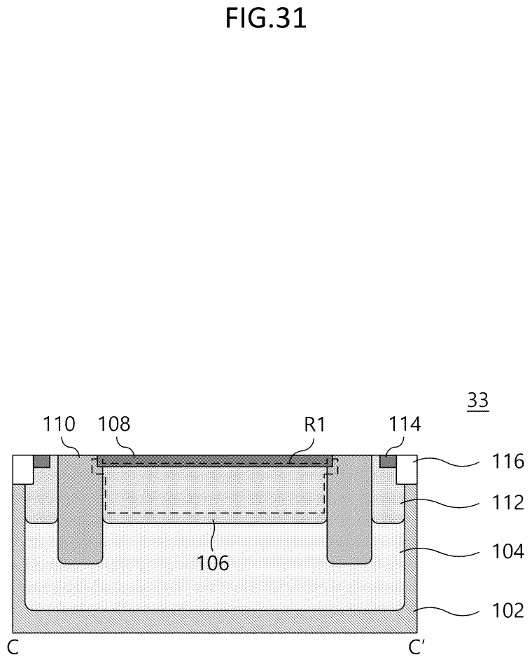

FIGS. 31 to 33 are cross-sectional views corresponding to line C-C′ in FIG. 19. For conciseness, differences from the previously described embodiments may be described.

Referring to FIG. 31, a single photon detection device 33 may be provided. Unlike what has been described with reference to FIGS. 1 and 2, the guard ring 110 may have a different conductivity type from the heavily doped region 108. The guard ring 110 may have substantially the same conductivity type as the first well 104 and the second well 106. The guard ring 110 may have a first conductivity type. The doping concentration of the guard ring 110 may be lower than the doping concentration of the heavily doped region 108. For example, the doping concentration of the guard ring 110 may be 1×10¹⁵˜1×10¹⁸ cm⁻³. The guard ring 110 may improve the breakdown characteristics of the single photon detection device 33. Specifically, the guard ring 110 may alleviate the concentration of the electric field at the edge of the heavily doped region 108, thereby preventing premature breakdown.

The guard ring 110 may fill the region between the relief region 112 and the second well 106 and the region between the relief region 112 and the heavily doped region 108. The guard ring 110 may directly contact the second well 106, the heavily doped region 108, and the relief region 112. The guard ring 110 may extend from the top surface of the single photon detection device 33 to a depth deeper than the second well 106 and the relief region 112. The bottom surface of the guard ring 110 may be located at a depth between the bottom surface of the second well 106 and the bottom surface of the first well 104. The bottom surface of the guard ring 110 may be located at a depth between the bottom surface of the relief region 112 and the bottom surface of the first well 104.

The depletion region R1 may further extend along the boundary between the heavily doped region 108 and the guard ring 110. For example, the depletion region R1 may be formed along the bottom surface and side surface of the heavily doped region 108. The size of the depletion region R1 may be determined by the doping concentrations of the heavily doped region 108, the second well 106, and the guard ring 110. When the single photon detection device 33 operates as a single photon avalanche diode (SPAD), the multiplication region to which an electric field with a maximum intensity of about 1×10⁵˜1×10⁶ V/cm is applied may expand along the boundary between the heavily doped region 108 and the guard ring 110. As the multiplication region expands, the light detection efficiency and fill factor of the single photon detection device 33 may increase.

As the guard ring 110 has the same conductivity type as the first well 104 and the second well 106, the breakdown voltage of the single photon detection device 33 may be lowered. As the breakdown voltage of the single photon detection device 33 is lowered, the power consumption required for the single photon detection device 33 to operate may be reduced.

When the guard ring 110 has a different conductivity type from the first well 104 and the second well 106, the electrical connection path between the contact region 114 and the depletion region R1 (multiplication region) may be formed between the guard ring 110 and the bottom surface of the first well 104. As the guard ring 110 has the same conductivity type as the first well 104 and the second well 106, the electrical connection path between the contact region 114 and the depletion region R1 (multiplication region) may be formed to pass through the guard ring 110. As a result, the single photon detection device 33 may have a relatively smaller parasitic series resistance compared to when the guard ring 110 has a different conductivity type from the first well 104 and the second well 106. As the parasitic series resistance decreases, the light detection efficiency may be improved.

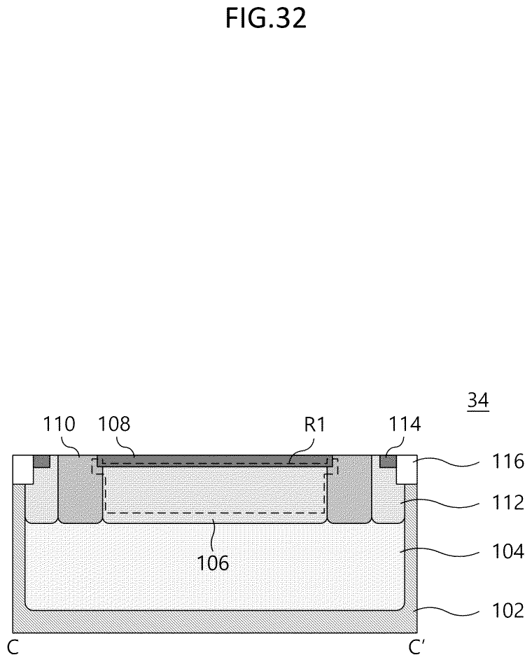

Referring to FIG. 32, a single photon detection device 34 may be provided. Unlike what has been described with reference to FIG. 31, the guard ring 110 may extend from the top surface of the single photon detection device 34 to a depth substantially equal to the bottom surface of the second well 106. For example, the bottom surface of the guard ring 110 may be placed at a depth substantially equal to the bottom surface of the second well 106. The guard ring 110 may extend from the top surface of the single photon detection device 34 to a depth substantially equal to the bottom surface of the relief region 112. For example, the bottom surface of the guard ring 110 may be placed at a depth substantially equal to the bottom surface of the relief region 112.

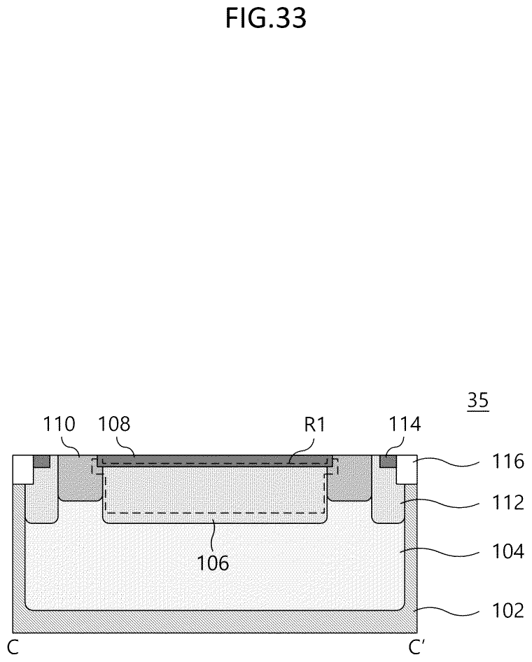

Referring to FIG. 33, a single photon detection device 35 may be provided. Unlike what has been described with reference to FIG. 31, the guard ring 110 may extend from the top surface of the single photon detection device 35 to a shallower depth than the second well 106 and the relief region 112. The bottom surface of the guard ring 110 may be located at a depth between the bottom surface of the second well 106 and the top surface of the second well 106. The bottom surface of the guard ring 110 may be located at a depth between the bottom surface of the relief region 112 and the top surface of the relief region 112.

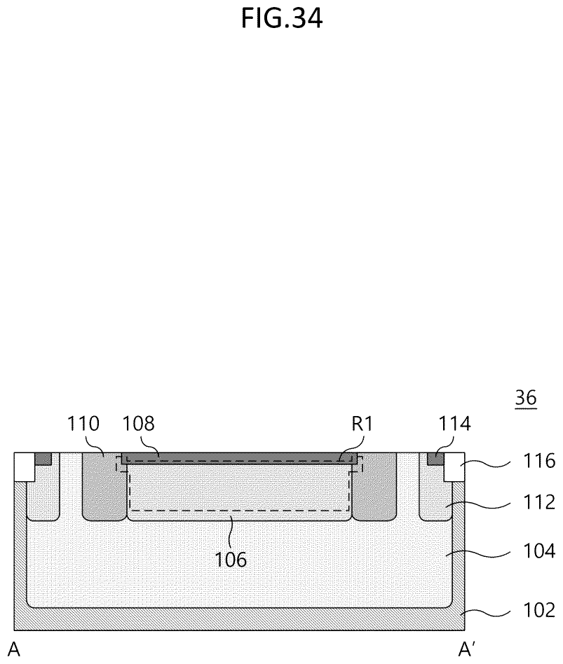

FIGS. 34 to 47 are cross-sectional views corresponding to line A-A′ in FIG. 1. For conciseness, differences from the previously described embodiments may be described.

Referring to FIG. 34, a single photon detection device 36 may be provided. Unlike what has been described with reference to FIGS. 1 and 2, the guard ring 110 may have a different conductivity type from the heavily doped region 108. The guard ring 110 may have substantially the same conductivity type as the first well 104 and the second well 106. The guard ring 110 may have a first conductivity type. The doping concentration of the guard ring 110 may be lower than the doping concentration of the heavily doped region 108. For example, the doping concentration of the guard ring 110 may be 1×10¹⁵˜1×10¹⁸ cm⁻³. The guard ring 110 may improve the breakdown characteristics of the single photon detection device 36. Specifically, the guard ring 110 may alleviate the concentration of the electric field at the edge of the heavily doped region 108, thereby preventing premature breakdown.

The depletion region R1 may further extend along the boundary between the heavily doped region 108 and the guard ring 110. For example, the depletion region R1 may be formed along the bottom surface and side surface of the heavily doped region 108. The size of the depletion region R1 may be determined by the doping concentrations of the heavily doped region 108, the second well 106, and the guard ring 110. When the single photon detection device 36 operates as a single photon avalanche diode (SPAD), the multiplication region to which an electric field with a maximum intensity of about 1×10⁵˜ 1×10⁶ V/cm is applied may expand along the boundary between the heavily doped region 108 and the guard ring 110. As the multiplication region expands, the light detection efficiency and fill factor of the single photon detection device 33 may increase. As the breakdown voltage of the single photon detection device 36 is lowered, the power consumption required for the single photon detection device 36 to operate may be reduced. As the electrical connection path between the contact region 114 and the depletion region R1 (multiplication region) is formed to pass through the guard ring 110, the parasitic series resistance of the single photon detection device 36 may decrease, and the light detection efficiency may be improved.

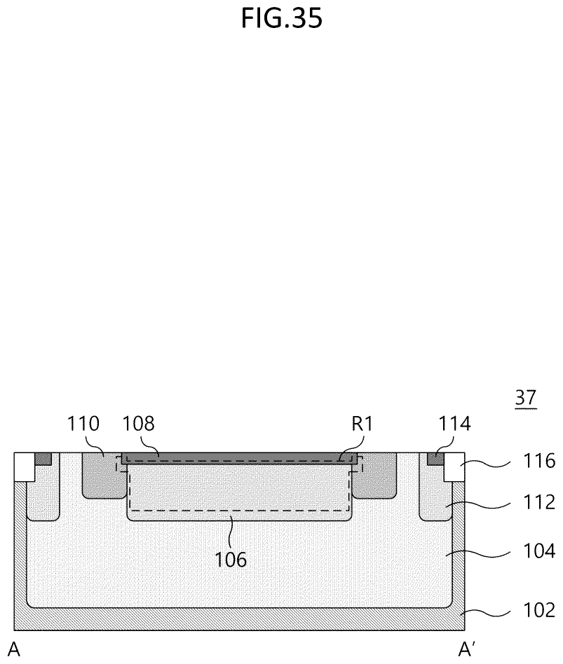

Referring to FIG. 35, a single photon detection device 37 may be provided. Unlike what is shown in FIG. 34, the guard ring 110 may extend from the top surface of the single photon detection device 37 to a shallower depth than the bottom surface of the second well 106. The bottom surface of the guard ring 110 may be located at a depth between the bottom surface of the second well 106 and the top surface of the second well 106.

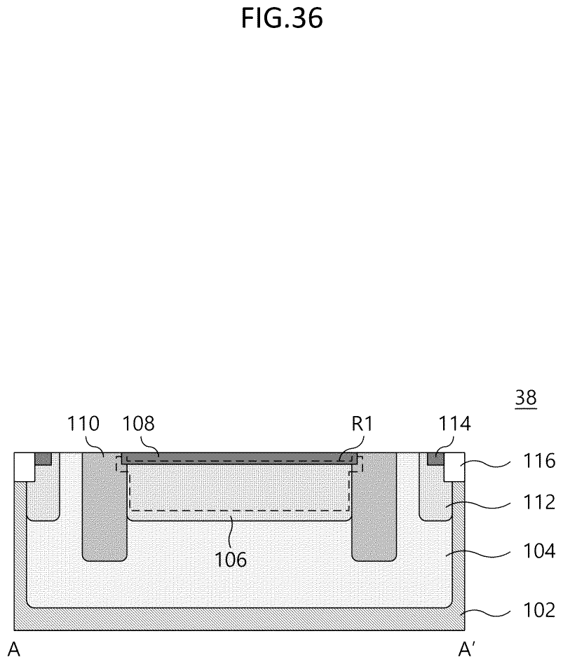

Referring to FIG. 36, a single photon detection device 38 may be provided. Unlike what is shown in FIG. 34, the guard ring 110 may extend from the top surface of the single photon detection device 38 to a deeper depth than the second well 106 and the relief region 112. The bottom surface of the guard ring 110 may be located at a depth between the bottom surface of the second well 106 and the bottom surface of the first well 104. The bottom surface of the guard ring 110 may be located at a depth between the bottom surface of the relief region 112 and the bottom surface of the first well 104.

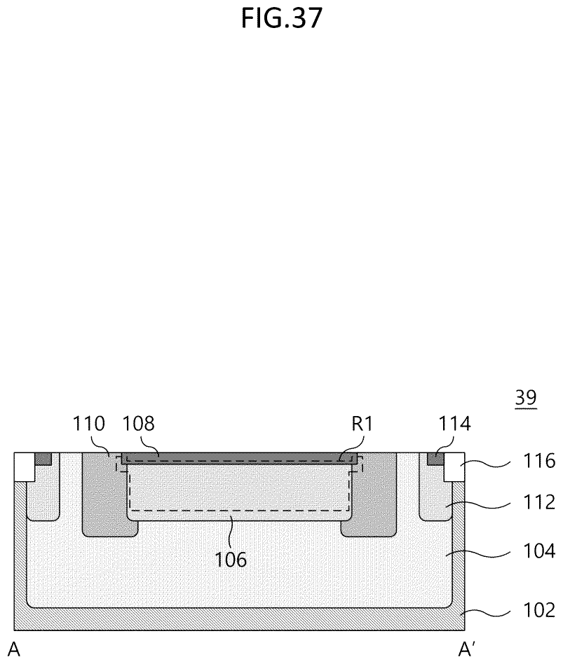

Referring to FIG. 37, a single photon detection device 39 may be provided. Unlike what is shown in FIG. 34, the guard ring 110 may extend from the top surface of the single photon detection device 39 to a deeper depth than the second well 106. The bottom surface of the guard ring 110 may be located at a depth between the bottom surface of the second well 106 and the bottom surface of the first well 104. The guard ring 110 may extend from the region on the side surface of the second well 106 to the region on the bottom surface of the second well 106. For example, the guard ring 110 may cover the edge portion of the bottom surface of the second well 106.

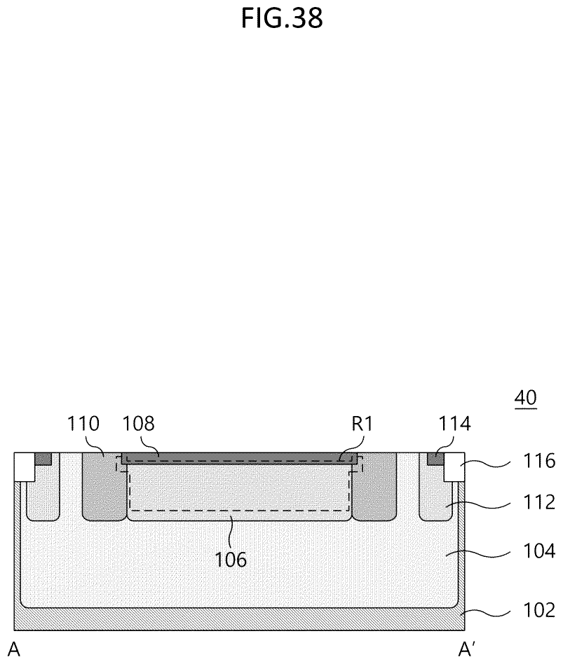

Referring to FIG. 38, a single photon detection device 40 may be provided. Unlike what is shown in FIG. 34, the first well 104 may cover the outer side surface of the relief region 112. The outer side surface of the relief region 112 may be located on the opposite side of the inner side surface of the relief region 112 facing the guard ring 110. From a planar perspective, the size of the first well 104 may be larger than the outer size of the relief region 112. In some exemplary embodiments, the first well 104 and the relief region 112 may have substantially the same center axis.

The substrate region 102 may be spaced apart from the relief region 112 by the first well 104 on the outer side surface of the relief region 112. The first well 104 may be interposed between the substrate region 102 and the relief region 112.

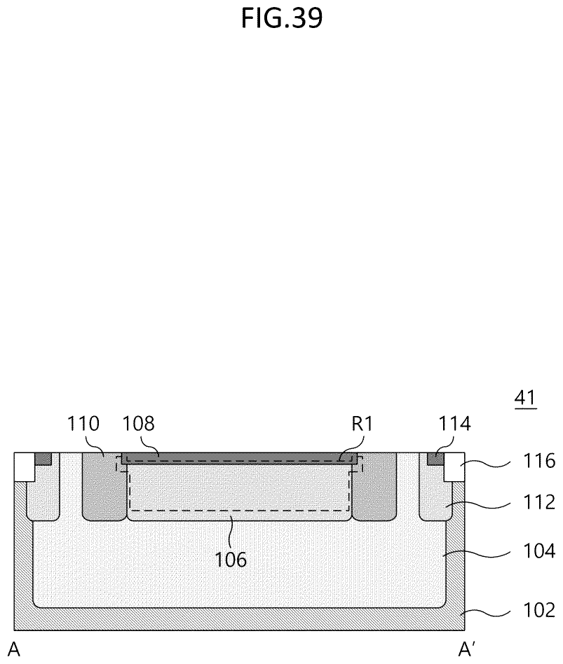

Referring to FIG. 39, a single photon detection device 41 may be provided. Unlike what is shown in FIG. 34, the relief region 112 may protrude from the side surface of the first well 104. The outer side surface of the relief region 112 and the side surface of the first well 104 may have a step difference.

The substrate region 102 may cover the relief region 112 protruding from the side surface of the first well 104.

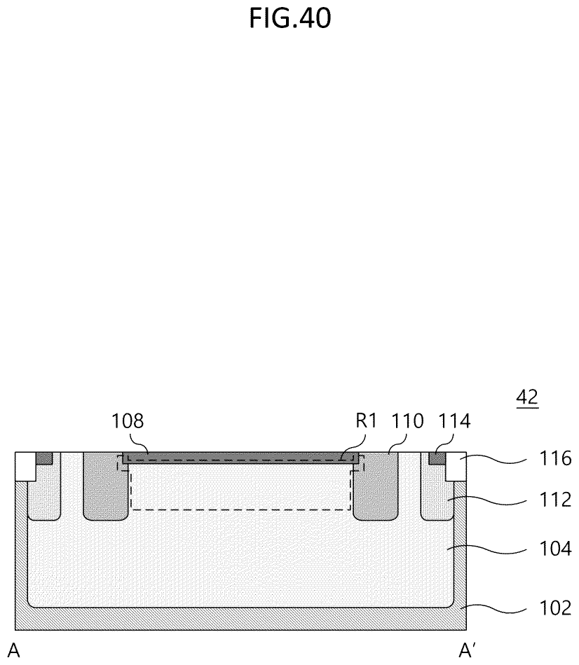

Referring to FIG. 40, a single photon detection device 42 may be provided. Unlike what is shown in FIG. 34, the first well 104 may contact the heavily doped region 108. The inner region of the guard ring 110 may be filled with the heavily doped region 108 and the first well 104. The depletion region R1 (multiplication region) may be formed along the interface between the heavily doped region 108 and the first well 104 and the interface between the heavily doped region 108 and the guard ring 110. For example, the depletion region R1 may be formed along the bottom surface and side surface of the heavily doped region 108. The size of the depletion region R1 may be determined by the doping concentrations of the heavily doped region 108, the second well 106, and the guard ring 110.

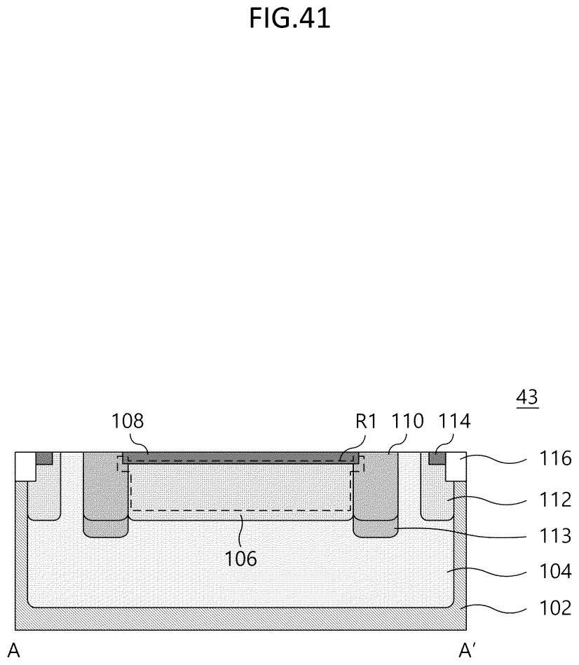

Referring to FIG. 41, a single photon detection device 43 may be provided. Unlike what is shown in FIG. 34, the single photon detection device 43 may further include an additional guard ring 113. The additional guard ring 113 may be provided on the bottom surface of the guard ring 110. In some exemplary embodiments, the side surface of the additional guard ring 113 may be aligned with the side surface of the guard ring 110. For example, the side surface of the additional guard ring 113 and the side surface of the guard ring 110 may form a coplanar surface. The additional guard ring 113 may have a different conductivity type from the heavily doped region 108. The additional guard ring 113 may have substantially the same conductivity type as the guard ring 110, the first well 104, and the second well 106. The additional guard ring 113 may have a first conductivity type. For example, the doping concentration of the additional guard ring 113 may be 1×10¹⁵˜ 1×10¹⁸ cm⁻³. The additional guard ring 113 may have a different doping concentration from the guard ring 110. The additional guard ring 113 may reduce or prevent the occurrence of premature breakdown together with the guard ring 110.

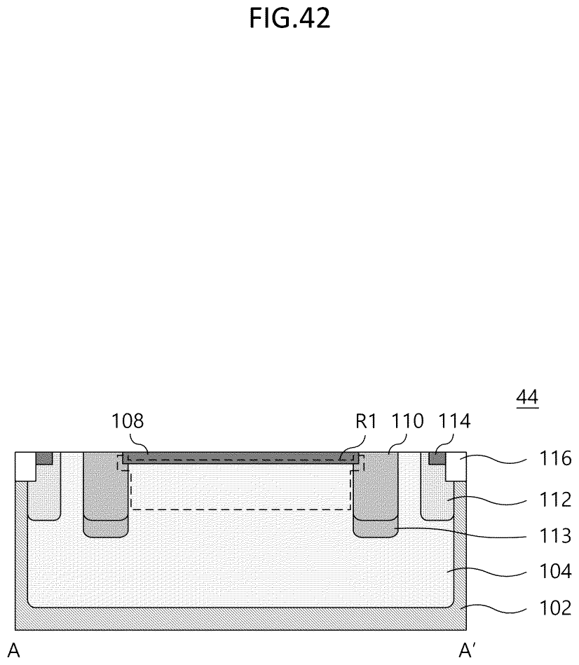

Referring to FIG. 42, a single photon detection device 44 may be provided. Unlike what is shown in FIG. 41, the first well 104 may contact the heavily doped region 108. The inner region of the guard ring 110 and the additional guard ring 113 may be filled with the heavily doped region 108 and the first well 104. The depletion region R1 (multiplication region) may be formed along the interface between the heavily doped region 108 and the first well 104 and the interface between the heavily doped region 108 and the guard ring 110. For example, the depletion region R1 may be formed along the bottom surface and side surface of the heavily doped region 108. The size of the depletion region R1 may be determined by the doping concentrations of the heavily doped region 108, the second well 106, the guard ring 110, and the additional guard ring 113.

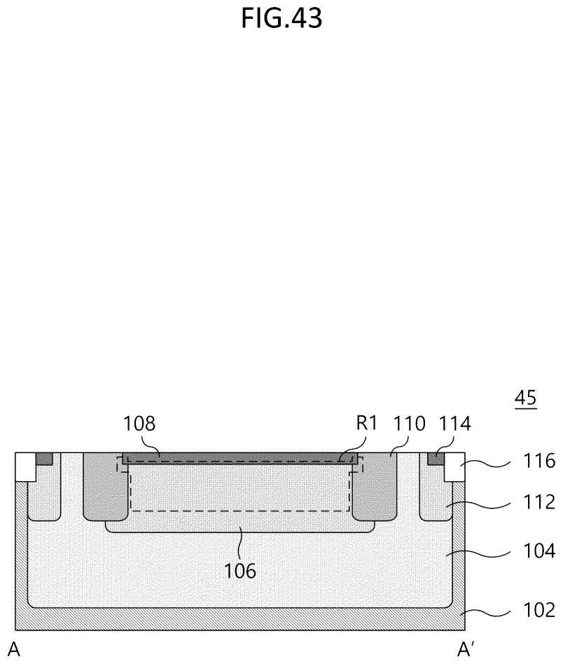

Referring to FIG. 43, a single photon detection device 45 may be provided. Unlike what is shown in FIG. 34, the second well 106 may extend from the top surface of the single photon detection device 45 to a deeper depth than the guard ring 110 and the relief region 112. The bottom surface of the second well 106 may be located at a depth between the bottom surface of the guard ring 110 and the bottom surface of the first well 104. The bottom surface of the second well 106 may be located at a depth between the bottom surface of the relief region 112 and the bottom surface of the first well 104. The second well 106 may extend from the region on the inner side surface of the guard ring 110 to the region on the bottom surface of the guard ring 110. For example, the second well 106 may cover the edge portion of the bottom surface of the guard ring 110. The second well 106 may contact the bottom surface of the guard ring 110.

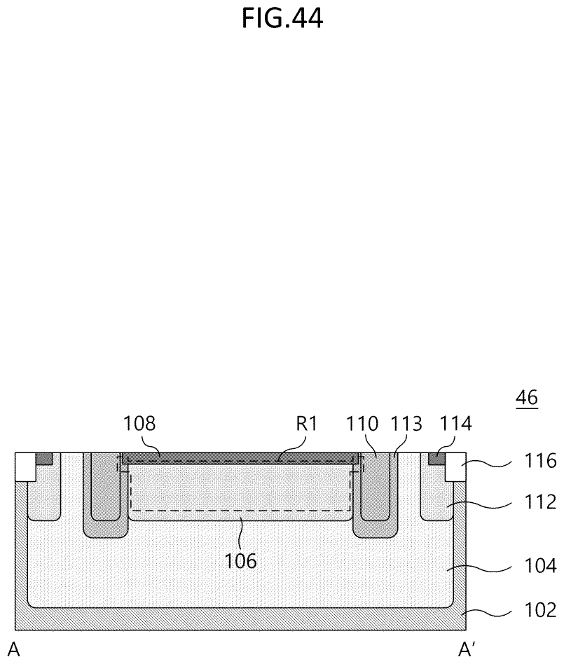

Referring to FIG. 44, a single photon detection device 46 may be provided. Unlike what is shown in FIG. 34, the single photon detection device 46 may further include an additional guard ring 113. The additional guard ring 113 may extend from the region on the bottom surface of the guard ring 110 to the region on the inner side surface and the outer side surface of the guard ring 110. For example, the additional guard ring 113 may cover the inner side surface and the outer side surface of the guard ring 110. The guard ring 110 may be spaced apart from the first well 104, the second well 106, and the heavily doped region 108 by the additional guard ring 113.

The additional guard ring 113 may have a different conductivity type from the heavily doped region 108. The additional guard ring 113 may have substantially the same conductivity type as the guard ring 110, the first well 104, and the second well 106. The additional guard ring 113 may have a first conductivity type. For example, the doping concentration of the additional guard ring 113 may be 1×10¹⁵˜ 1×10¹⁸ cm⁻³. The additional guard ring 113 may have a different doping concentration from the guard ring 110. The additional guard ring 113 may reduce or prevent the occurrence of premature breakdown together with the guard ring 110.

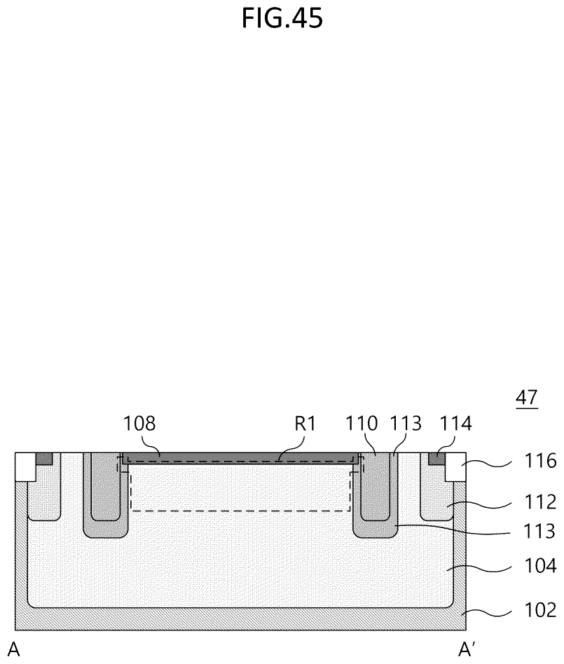

Referring to FIG. 45, a single photon detection device 47 may be provided. Unlike what is shown in FIG. 44, the first well 104 may contact the heavily doped region 108. The inner region of the additional guard ring 113 may be filled with the heavily doped region 108 and the first well 104. The depletion region R1 (multiplication region) may be formed along the interface between the heavily doped region 108 and the first well 104 and the interface between the heavily doped region 108 and the additional guard ring 113. For example, the depletion region R1 may be formed along the bottom surface and side surface of the heavily doped region 108. The size of the depletion region R1 may be determined by the doping concentrations of the heavily doped region 108, the second well 106, the guard ring 110, and the additional guard ring 113.

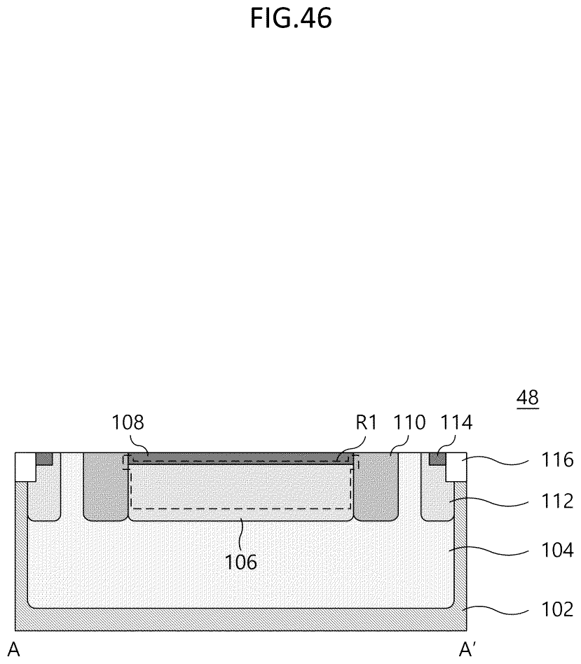

Referring to FIG. 46, a single photon detection device 48 may be provided. Unlike what is shown in FIG. 34, the heavily doped region 108 and the second well 106 may have substantially the same width inside the guard ring 110. The side surface of the heavily doped region 108 may be aligned with the side surface of the second well 106. For example, the side surface of the heavily doped region 108 may form a coplanar surface with the side surface of the second well 106.

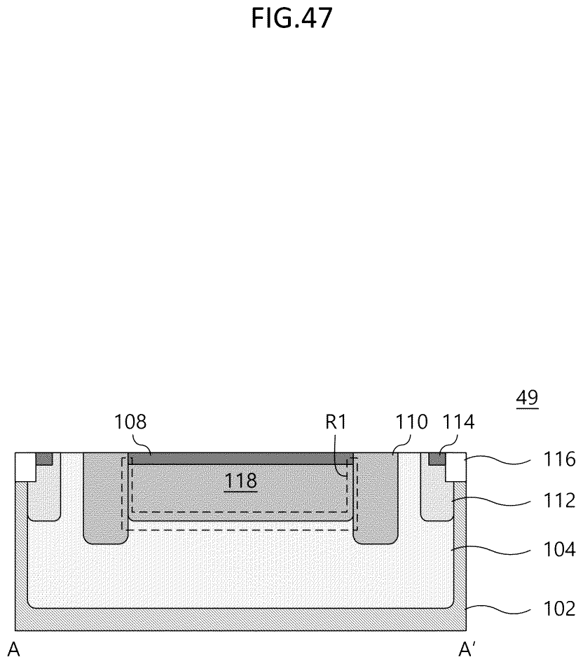

Referring to FIG. 47, a single photon detection device 49 may be provided. Unlike what is shown in FIG. 34, a third well 118 may be provided between the first well 104 and the heavily doped region 108 instead of the second well 106. The third well 118 may space the heavily doped region 108 and the first well 104 apart from each other. The third well 118 may be provided on the bottom surface of the heavily doped region 108. The side surface of the third well 118 and the side surface of the heavily doped region 108 may be aligned. For example, the side surface of the third well 118 and the side surface of the heavily doped region 108 may form a coplanar surface. The third well 118 may have the same conductivity type as the heavily doped region 108. The third well 118 may have a second conductivity type. The doping concentration of the third well 118 may be lower than the doping concentration of the heavily doped region 108 and higher than the doping concentration of the guard ring 110. For example, the doping concentration of the third well 118 may be 1×10¹⁶˜ 1×10¹⁸ cm⁻³. The depletion region R1 may be formed adjacent to the boundary between the third well 118 and the first well 104.

The guard ring 110 may extend from the top surface of the single photon detection device 49 to a position deeper than the bottom surface of the third well 118. The bottom surface of the guard ring 110 may be placed closer to the bottom surface of the first well 104 than the bottom surface of the third well 118. The guard ring 110 may have a different conductivity type from the third well 118. The guard ring 110 may have a smaller doping concentration than the third well 118. For example, the doping concentration of the guard ring 110 may be 1×10¹⁵˜ 1×10¹⁷ cm⁻³.

The depletion region R1 may extend along the boundary between the third well 118 and the first well 104, the boundary between the third well 118 and the guard ring 110, and the boundary between the heavily doped region 108 and the guard ring 110. For example, the depletion region R1 may be formed along the side surface of the heavily doped region 108, the side surface and bottom surface of the third well 118. The size of the depletion region R1 may be determined by the doping concentrations of the heavily doped region 108, the third well 118, the guard ring 110, and the first well 104.

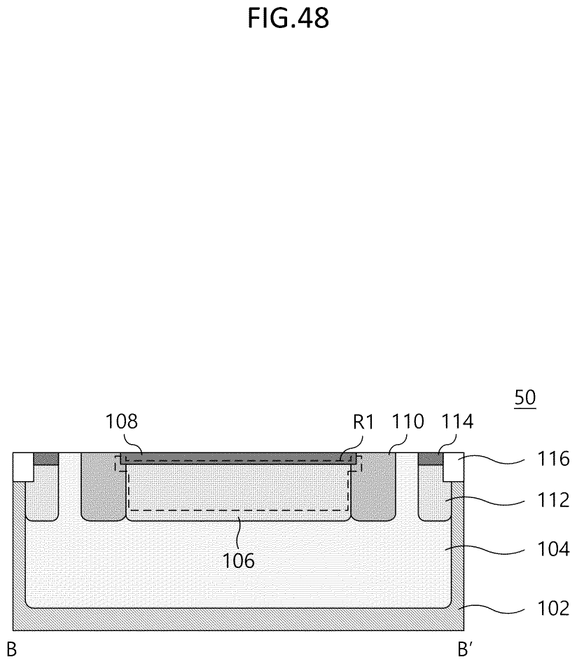

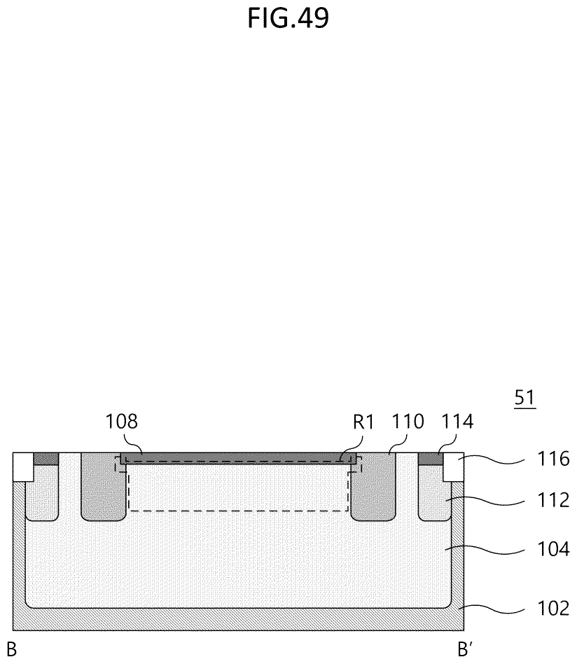

FIGS. 48 and 49 are cross-sectional views corresponding to line B-B′ in FIG. 17. For conciseness, differences from the previously described embodiments may be described.

Referring to FIG. 48, a single photon detection device 50 may be provided. Unlike what is shown in FIG. 34, the inner side surface of the contact 114 may be aligned with the inner side surface of the relief region 112. For example, the inner side surface of the contact 114 and the inner side surface of the relief region 112 may form a coplanar surface. The inner side surface of the contact 114 may directly contact the first well 104. The outer side surface of the contact 114 may directly contact the device isolation region 116. The bottom surface of the contact 114 may directly contact the relief region 112.

Referring to FIG. 49, a single photon detection device 51 may be provided. Unlike what is shown in FIG. 48, the first well 104 may contact the heavily doped region 108. The inner region of the guard ring 110 may be filled with the heavily doped region 108 and the first well 104. The depletion region R1 (multiplication region) may be formed along the interface between the heavily doped region 108 and the first well 104 and the interface between the heavily doped region 108 and the guard ring 110. For example, the depletion region R1 may be formed along the bottom surface and side surface of the heavily doped region 108. The size of the depletion region R1 may be determined by the doping concentrations of the heavily doped region 108, the second well 106, and the guard ring 110.

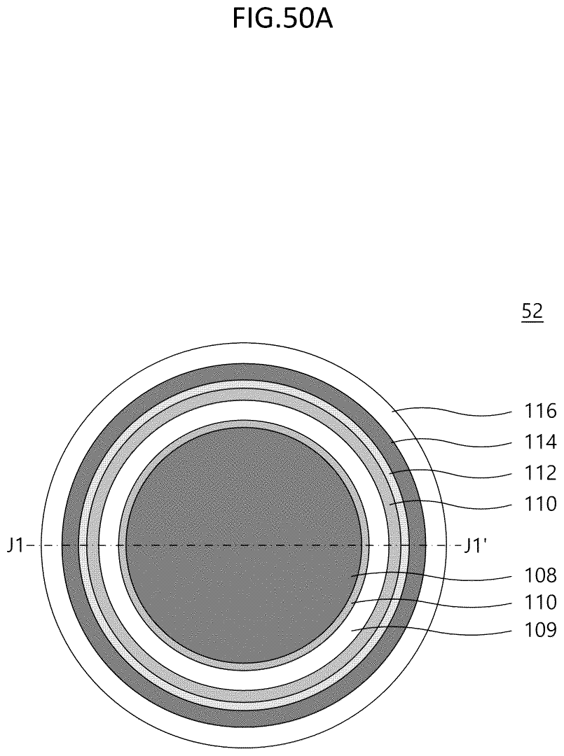

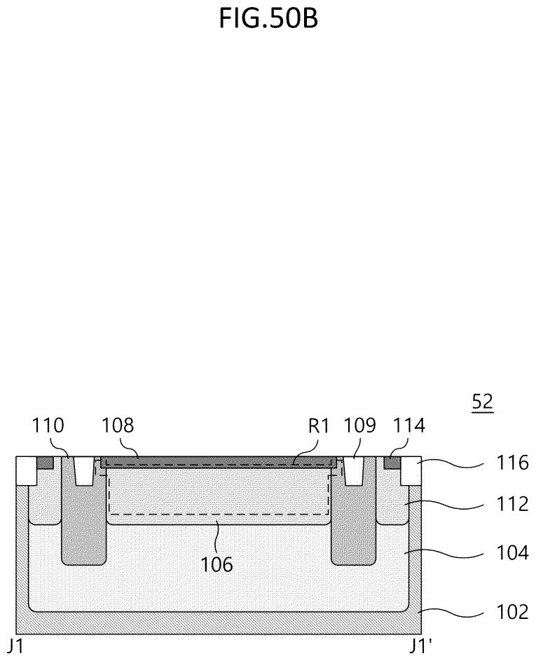

FIG. 50A is a plan view of a single photon detection device according to example embodiments. FIG. 50B is a cross-sectional view taken along line J1-J1′ in FIG. 50A. For conciseness, differences from the previously described embodiments may be described.

Referring to FIGS. 50A and 50B, a single photon detection device 52 may be provided. Unlike what is shown in FIG. 31, the single photon detection device 52 may include an insulating pattern 109. The insulating pattern 109 may surround the heavily doped region 108. For example, the insulating pattern 109 may have a ring shape extending along the side surface of the heavily doped region 108. Although the insulating pattern 109 is shown as being spaced apart from the heavily doped region 108, this is illustrative. In another example, the insulating pattern 109 may directly contact the heavily doped region 108. The insulating pattern 109 may be formed from the same height as the top surface of the heavily doped region 108 to a certain depth. As an example, the insulating pattern 109 may extend to a depth between the top surface and the bottom surface of the second well 106. The depth of the insulating pattern 109 may be determined as needed. The insulating pattern 109 may be inserted into the guard ring 110.

The insulating pattern 109 may include an electrical insulating material. For example, the insulating pattern 109 may include silicon oxide (e.g., SiO₂), silicon nitride (e.g., SiN), silicon oxynitride (e.g., SiON), or a combination thereof. In one example, the insulating pattern 109 may be an STI (shallow trench isolation) formed by etching a portion of the semiconductor substrate and filling the etched region with an insulating material.

The insulating pattern 109 may have a higher critical electric field (critical E-field) that causes an avalanche effect than the semiconductor substrate. Accordingly, the insulating pattern 109 may alleviate the concentration of the electric field at the edge of the heavily doped region 108, thereby reducing or preventing premature breakdown. The insulating pattern 109 may reduce or prevent surface noise of the single photon detection device 52. The insulating pattern 109 may be formed before the guard ring 110. During the ion implantation process for forming the guard ring 110, the insulating pattern 109 may reduce the ion implantation effect on the guard ring located below the insulating pattern 109. The guard ring located below the insulating pattern 109 may have a smaller doping concentration than its surroundings. As a result, the performance of the guard ring 110 may be improved. In addition, in one example, the insulating pattern 109 may enhance the fill factor or efficiency by allowing the depletion region R1 or the multiplication region to be formed larger.

The depletion region R1 may be provided between the heavily doped region 108 and the insulating pattern 109. For example, a portion of the depletion region R1 may be formed in the guard ring 110 between the heavily doped region 108 and the insulating pattern 109. The depletion region R1 may be provided on the inner side surface of the insulating pattern 109.

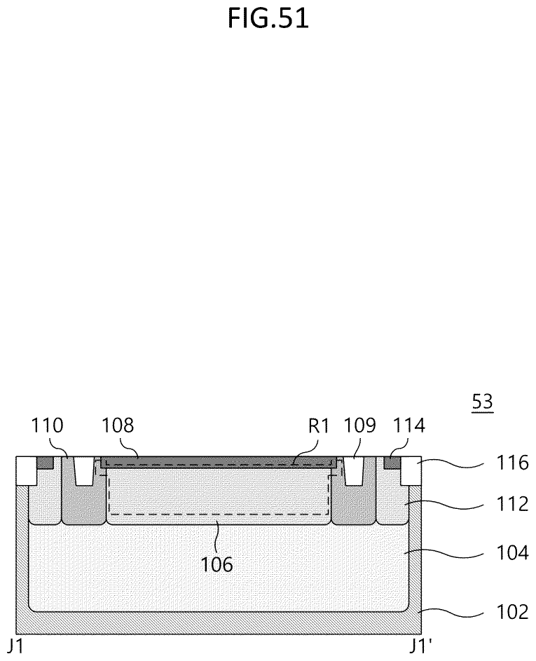

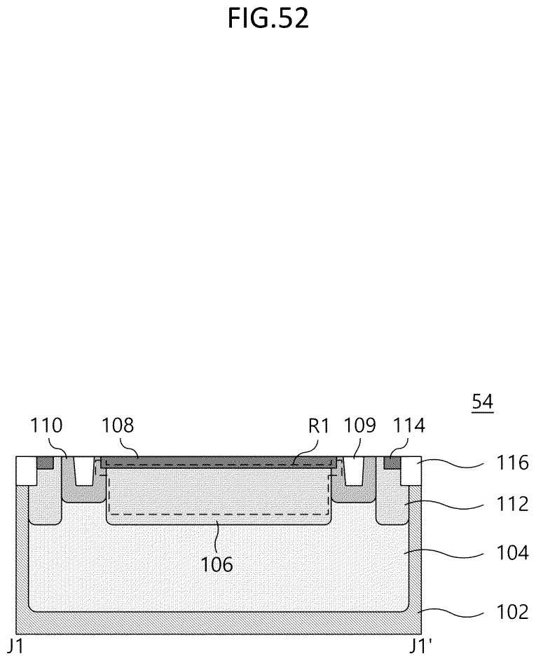

FIGS. 51 and 52 are cross-sectional views corresponding to line J1-J1′ in FIG. 50A. For conciseness, differences from the previously described embodiments may be described.

Referring to FIGS. 51 and 52, single photon detection devices 53 and 54 may be provided. Unlike what is shown in FIGS. 32 and 33, respectively, the single photon detection devices 53 and 54 may include the insulating pattern 109. The description of the insulating pattern 109 may be substantially the same as that described with reference to FIGS. 50A and 50B.

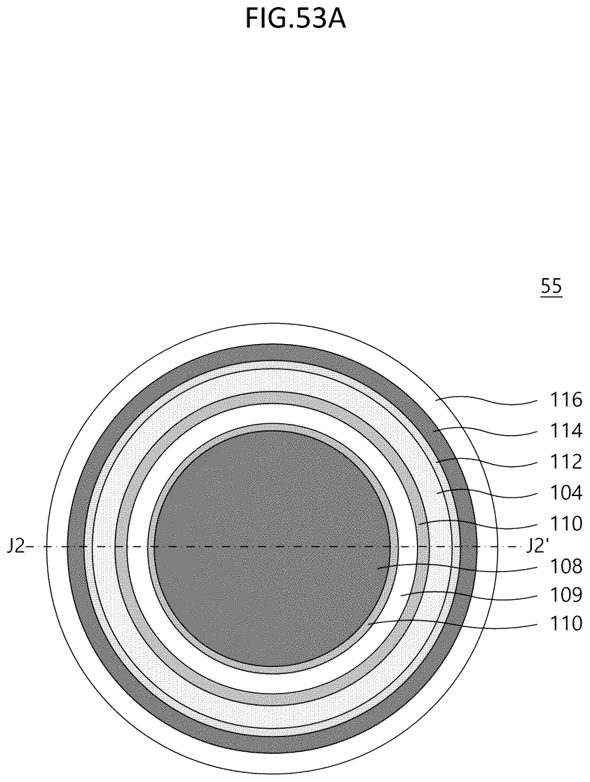

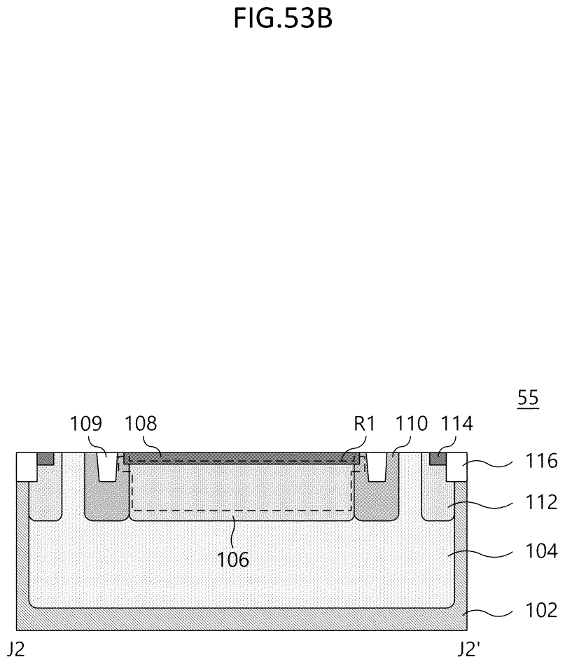

FIG. 53A is a plan view of a single photon detection device according to example embodiments. FIG. 53B is a cross-sectional view taken along line J2-J2′ in FIG. 53A. For conciseness, differences from the previously described embodiments may be described.

Referring to FIGS. 53A and 53B, a single photon detection device 55 may be provided. Unlike what is shown in FIG. 34, the single photon detection device 55 may include the insulating pattern 109. The description of the insulating pattern 109 may be substantially the same as that described with reference to FIGS. 50A and 50B.

The depletion region R1 may be provided between the heavily doped region 108 and the insulating pattern 109. For example, a portion of the depletion region R1 may be formed in the guard ring 110 between the heavily doped region 108 and the insulating pattern 109. The depletion region R1 may be provided on the inner side surface of the insulating pattern 109.

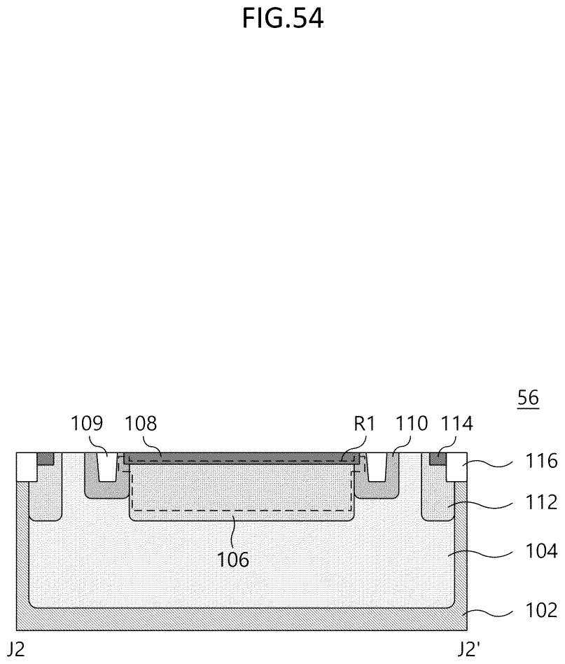

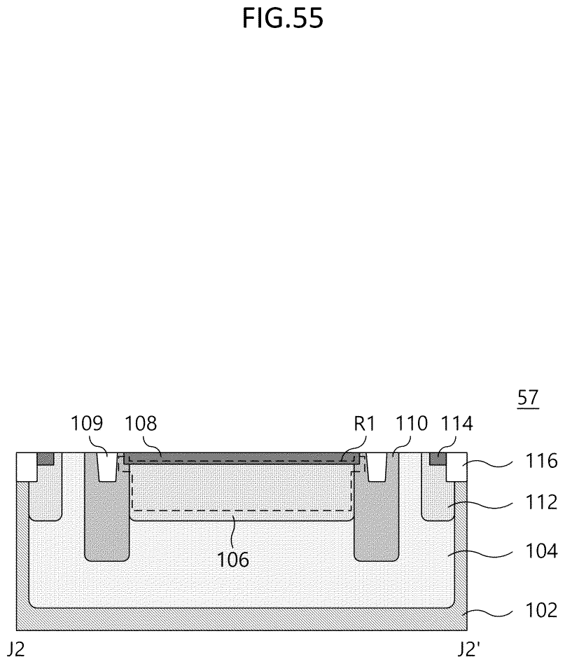

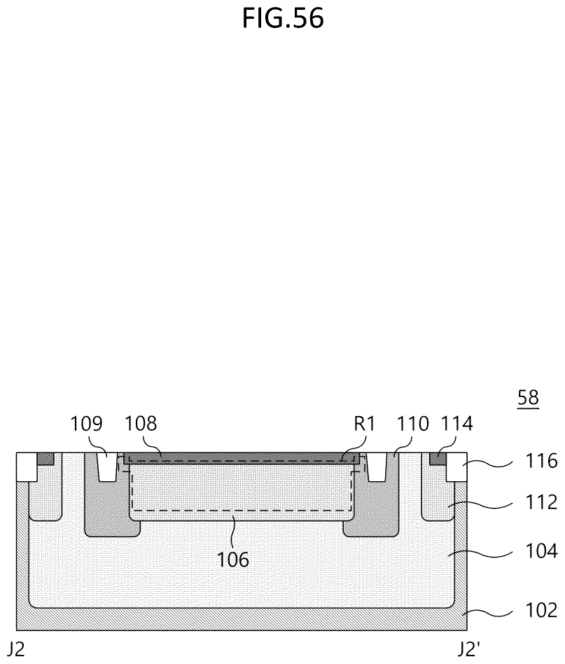

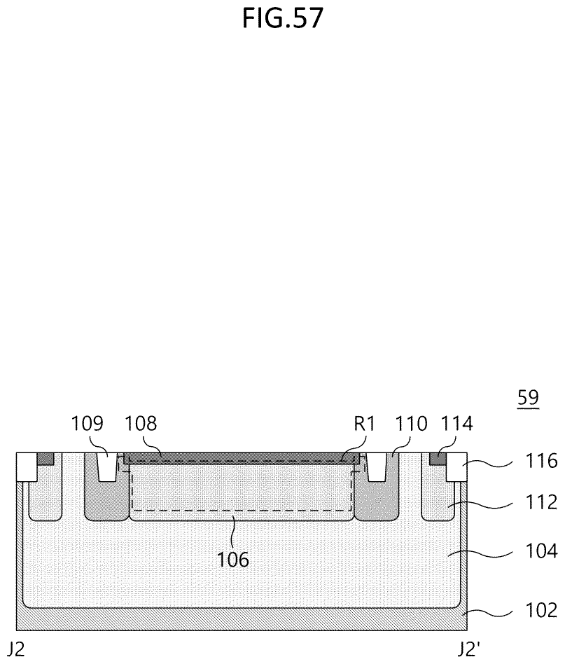

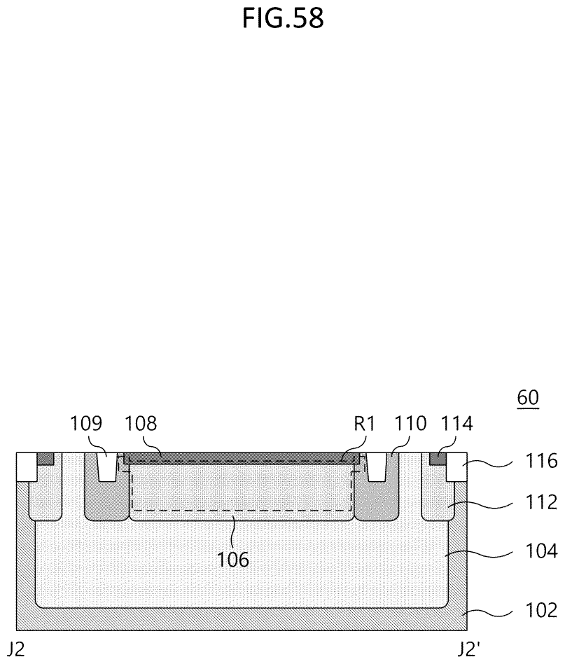

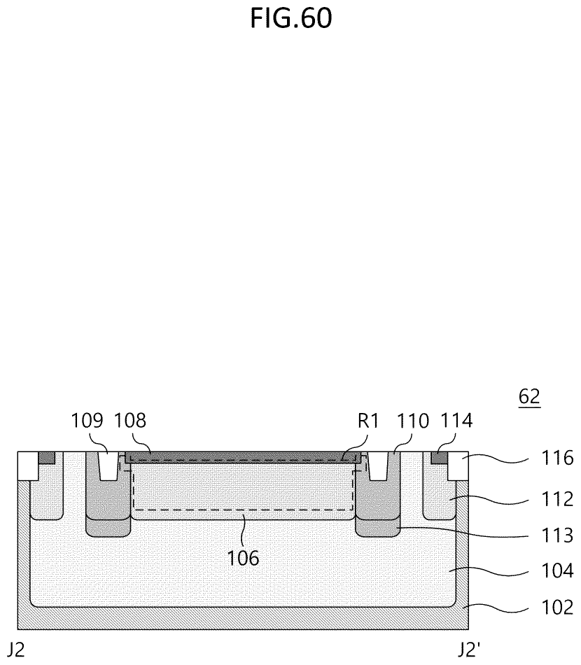

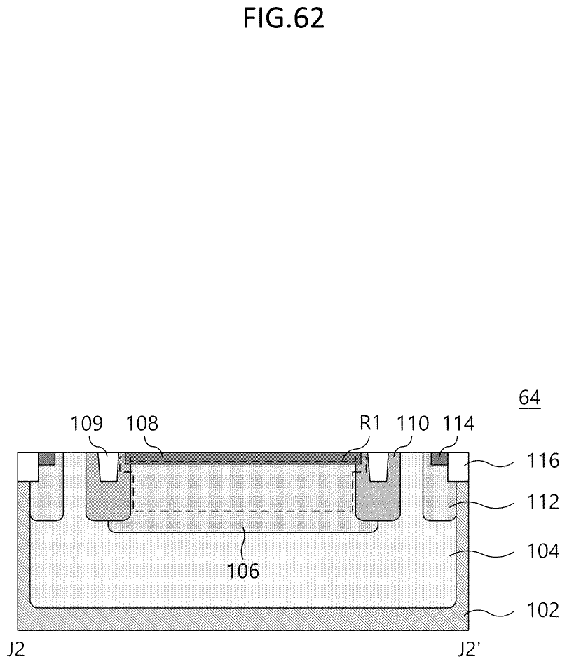

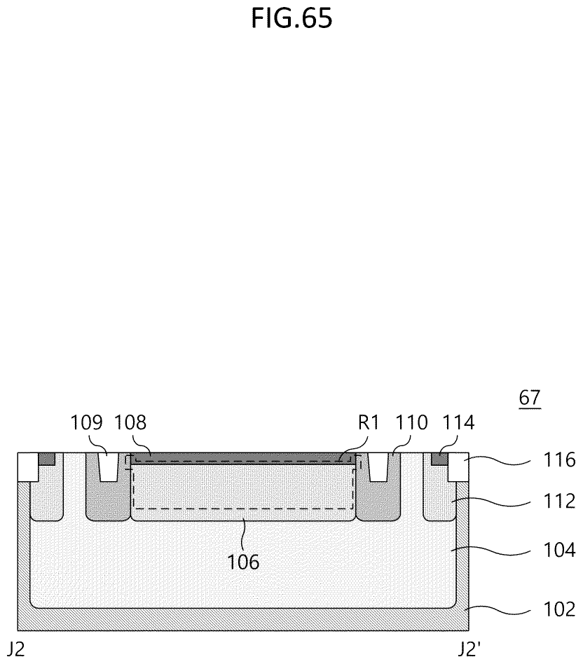

FIGS. 54 to 66 are cross-sectional views corresponding to line J2-J2′ in FIG. 53A. For conciseness, differences from the previously described embodiments may be described.

Referring to FIGS. 54 to 58, 60, 62, and 65, single photon detection devices 56, 57, 58, 59, 60, 62, 64, and 67 may be provided. Unlike what is shown in FIGS. 34 to 39, 41, 43, and 46, respectively, the single photon detection devices 56, 57, 58, 59, 60, 62, 64, and 67 may include the insulating pattern 109. The description of the insulating pattern 109 may be substantially the same as that described with reference to FIGS. 50A and 50B.

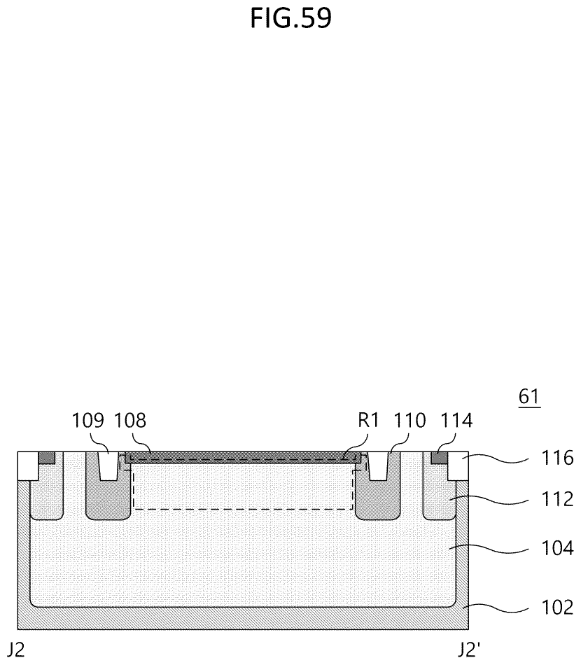

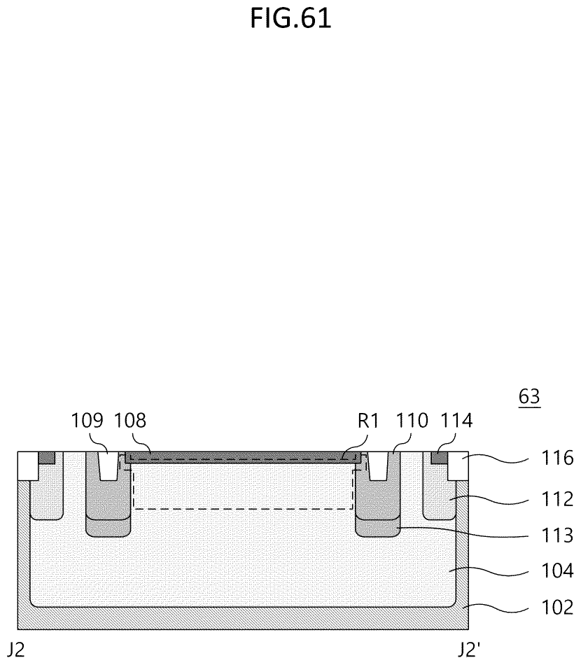

Referring to FIGS. 59 and 61, single photon detection devices 61 and 63 may be provided. Unlike what is shown in FIGS. 40 and 42, respectively, the single photon detection devices 61 and 63 may include the insulating pattern 109. Unlike what is described with reference to FIGS. 50A and 50B, the insulating pattern 109 may extend from the same height as the top surface of the heavily doped region 108 to a depth between the top surface and the bottom surface of the first well 104. The depth of the insulating pattern 109 may be determined as needed.

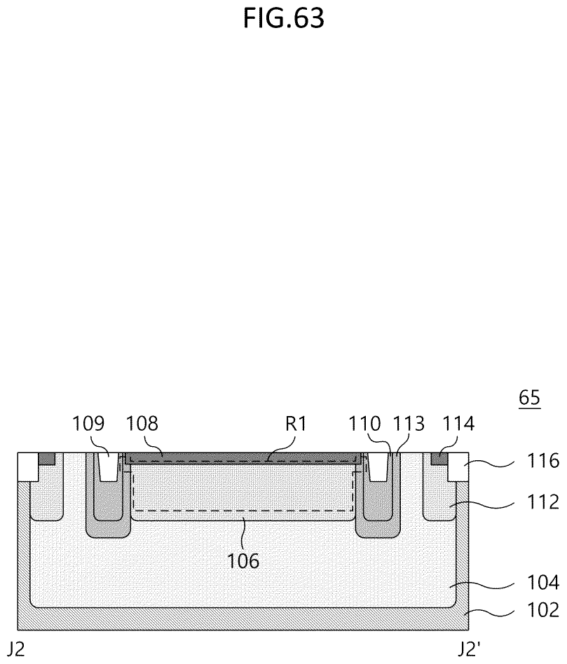

Referring to FIG. 63, a single photon detection device 65 may be provided. Unlike what is shown in FIG. 44, the single photon detection device 65 may include the insulating pattern 109. The depletion region R1 may be provided between the heavily doped region 108 and the insulating pattern 109. Unlike what is described with reference to FIGS. 50A and 50B, a portion of the depletion region R1 may be formed in the guard ring 110 and the additional guard ring 113 between the heavily doped region 108 and the insulating pattern 109.

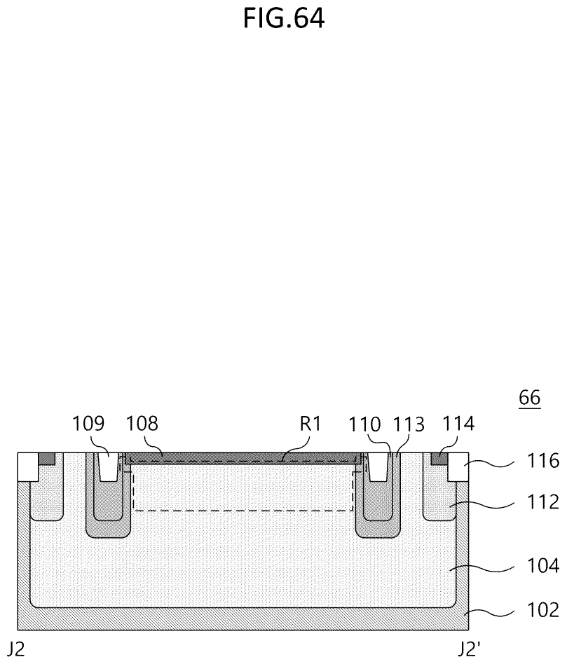

Referring to FIG. 64, a single photon detection device 66 may be provided. Unlike what is shown in FIG. 45, the single photon detection device 66 may include the insulating pattern 109. The depletion region R1 may be provided between the heavily doped region 108 and the insulating pattern 109. Unlike what is described with reference to FIGS. 50A and 50B, the insulating pattern 109 may extend from the same height as the top surface of the heavily doped region 108 to a depth between the top surface and the bottom surface of the first well 104. The depth of the insulating pattern 109 may be determined as needed. A portion of the depletion region R1 may be formed in the guard ring 110 and the additional guard ring 113 between the heavily doped region 108 and the insulating pattern 109.

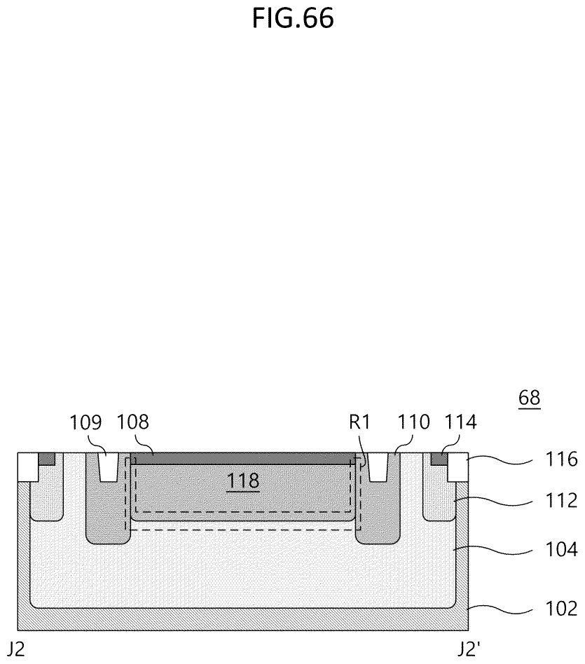

Referring to FIG. 66, a single photon detection device 68 may be provided. Unlike what is shown in FIG. 47, the single photon detection device 68 may include the insulating pattern 109. Unlike what is described with reference to FIGS. 50A and 50B, the insulating pattern 109 may extend from the same height as the top surface of the heavily doped region 108 to a depth between the top surface and the bottom surface of the third well 118. The depth of the insulating pattern 109 may be determined as needed.

The depletion region R1 may be provided between the heavily doped region 108 and the insulating pattern 109 and between the third well 118 and the insulating pattern 109. For example, a portion of the depletion region R1 may be formed in the guard ring 110 between the heavily doped region 108 and the insulating pattern 109 and in the guard ring 110 between the third well 118 and the insulating pattern 109. The depletion region R1 may be provided on the inner side surface of the insulating pattern 109.

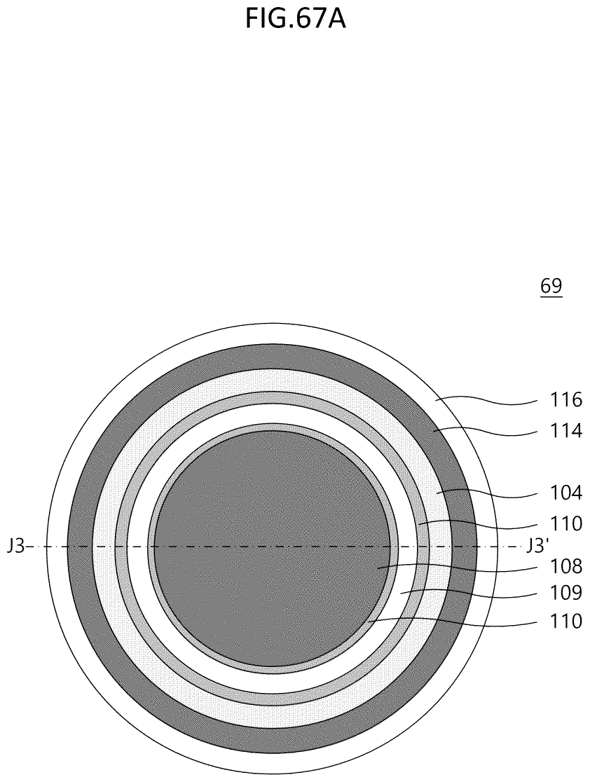

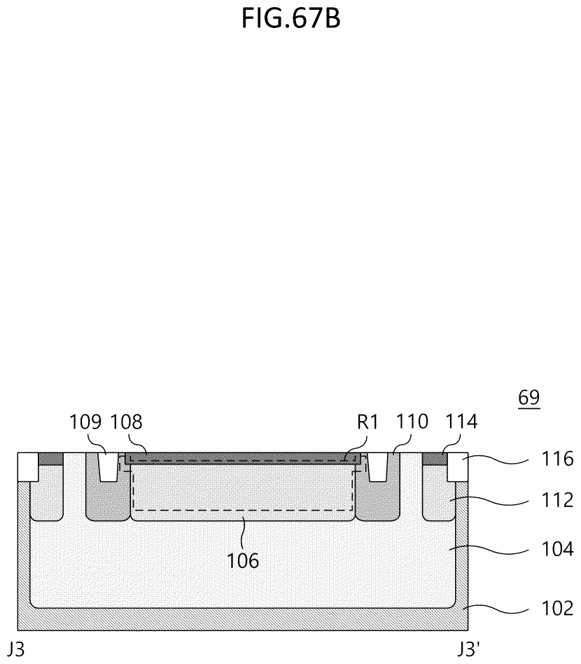

FIG. 67A is a plan view of a single photon detection device according to example embodiments. FIG. 67B is a cross-sectional view taken along line J3-J3′ in FIG. 67A. For conciseness, differences from the previously described embodiments may be described.

Referring to FIGS. 67A and 67B, a single photon detection device 69 may be provided. Unlike what is shown in FIG. 48, the single photon detection device 69 may include the insulating pattern 109. The description of the insulating pattern 109 may be substantially the same as that described with reference to FIGS. 50A and 50B.

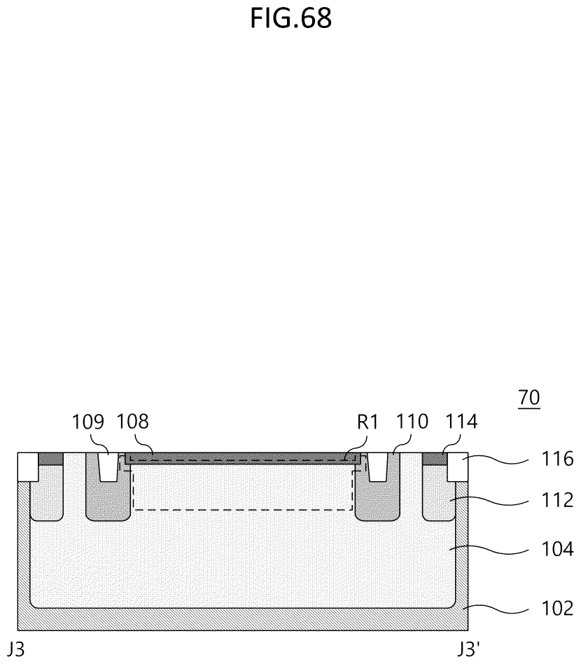

FIG. 68 is a cross-sectional view corresponding to line J3-J3′ in FIG. 67A. For conciseness, differences from the previously described embodiments may be described.

Referring to FIG. 68, a single photon detection device 70 may be provided. Unlike what is shown in FIG. 49, the single photon detection device 70 may include the insulating pattern 109. The description of the insulating pattern 109 may be substantially the same as that described with reference to FIGS. 50A and 50B.

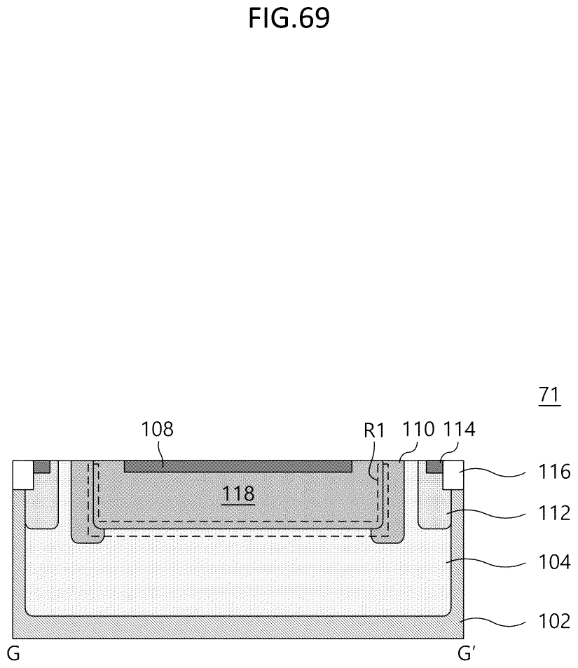

FIG. 69 is a cross-sectional view corresponding to line G-G′ in FIG. 28. For conciseness, differences from the previously described embodiments may be described.

Referring to FIG. 69, a single photon detection device 71 may be provided. Unlike what has been described with reference to FIGS. 1 and 2, a third well 118 may be provided between the first well 104 and the heavily doped region 108. The third well 118 may cover the side surface and bottom surface of the heavily doped region 108. The third well 118 may space the heavily doped region 108 and the first well 104 apart from each other. The third well 118 may have a second conductivity type. The doping concentration of the third well 118 may be lower than the doping concentration of the heavily doped region 108. For example, the doping concentration of the third well 118 may be 1×10¹⁶˜ 1×10¹⁸ cm⁻³.

A guard ring 110 may be provided on the side surface of the third well 118. The guard ring 110 may extend from the top surface of the single photon detection device 71 to a depth deeper than the third well 118 and the relief region 112. The bottom surface of the guard ring 110 may be located at a depth between the bottom surface of the third well 118 and the bottom surface of the first well 104. The bottom surface of the guard ring 110 may be located at a depth between the bottom surface of the relief region 112 and the bottom surface of the first well 104. The guard ring 110 may extend from the region on the side surface of the third well 118 to the region on the bottom surface of the third well 118. For example, the guard ring 110 may cover the edge portion of the bottom surface of the third well 118.

The guard ring 110 may have a different conductivity type from the heavily doped region 108. The guard ring 110 may have substantially the same conductivity type as the first well 104 and the second well 106. The guard ring 110 may have a first conductivity type. The guard ring 110 may have a smaller doping concentration than the third well 118. For example, the doping concentration of the guard ring 110 may be 1×10¹⁵˜ 1×10¹⁸ cm⁻³. The guard ring 110 may improve the breakdown characteristics of the single photon detection device 71. Specifically, the guard ring 110 may alleviate the concentration of the electric field at the edge of the heavily doped region 108, thereby preventing premature breakdown.

The depletion region R1 may extend along the boundary between the third well 118 and the first well 104 and the boundary between the third well 118 and the guard ring 110. For example, the depletion region R1 may be formed along the side surface and bottom surface of the third well 118. The size of the depletion region R1 may be determined by the doping concentrations of the third well 118, the guard ring 110, and the first well 104.

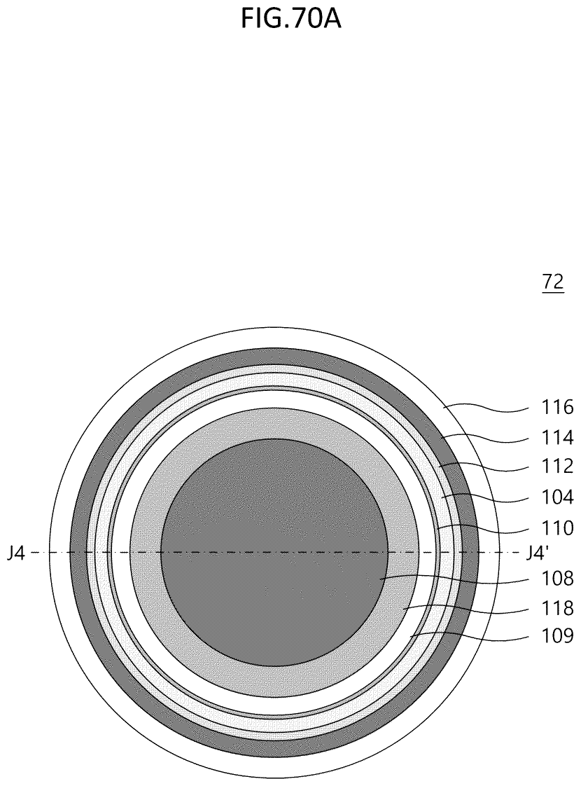

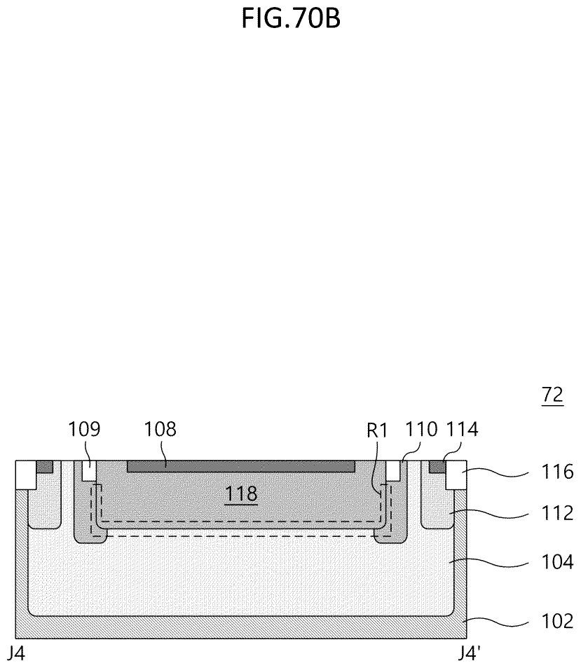

FIG. 70A is a plan view of a single photon detection device according to example embodiments. FIG. 70B is a cross-sectional view taken along line J4-J4′ in FIG. 70A. For the sake of brevity, differences from the previously described embodiments may be described.

Referring to FIGS. 70A and 70B, a single photon detection device 72 may be provided. Unlike what is shown in FIG. 69, the single photon detection device 72 may include an insulating pattern 109. Unlike what is described with reference to FIGS. 50A and 50B, the insulating pattern 109 may be provided between the guard ring 110 and the third well 118. One side surface and bottom surface of the insulating pattern 109 may contact the guard ring 110. The other side surface of the insulating pattern 109 may contact the third well 118.

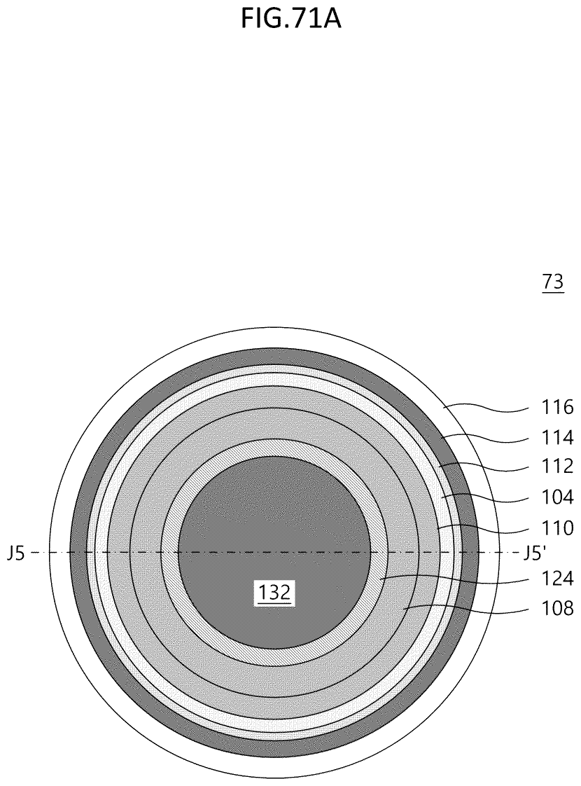

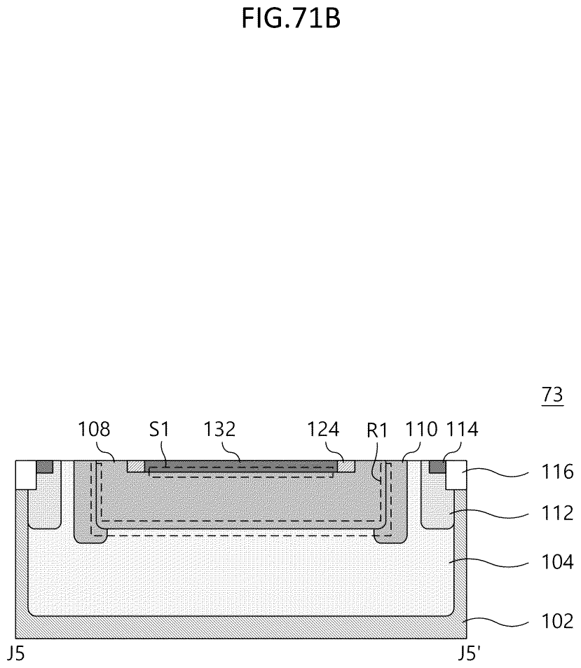

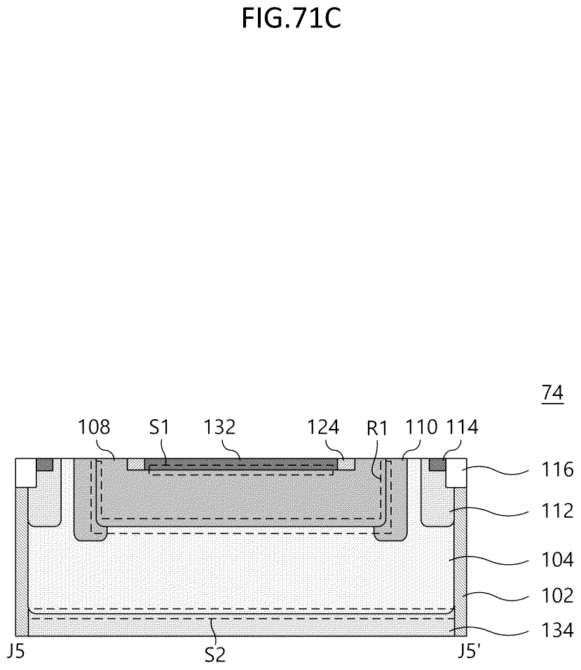

FIG. 71A is a plan view of a single photon detection device according to example embodiments. FIG. 71B is a cross-sectional view taken along line J5-J5′ in FIG. 71A. For the sake of brevity, differences from the previously described embodiments may be described.

Referring to FIGS. 71A and 71B, a single photon detection device 73 may be provided. Unlike what is shown in FIGS. 1 and 2, the heavily doped region 108 may extend to a depth adjacent to the bottom surface of the relief region 112. The first well 104 may contact the heavily doped region 108. The second well 106 may not be provided.

A guard ring 110 may be provided on the side surface of the heavily doped region 108. The guard ring 110 may extend from the top surface of the single photon detection device 73 to a depth deeper than the heavily doped region 108 and the relief region 112. The bottom surface of the guard ring 110 may be located at a depth between the bottom surface of the heavily doped region 108 and the bottom surface of the first well 104. The bottom surface of the guard ring 110 may be located at a depth between the bottom surface of the relief region 112 and the bottom surface of the first well 104. The guard ring 110 may extend from the region on the side surface of the heavily doped region 108 to the region on the bottom surface of the heavily doped region 108. For example, the guard ring 110 may cover the edge portion of the bottom surface of the heavily doped region 108.

The guard ring 110 may have a different conductivity type from the heavily doped region 108. The guard ring 110 may have substantially the same conductivity type as the first well 104. The guard ring 110 may have a first conductivity type. The guard ring 110 may have a smaller doping concentration than the heavily doped region 108. For example, the doping concentration of the guard ring 110 may be 1×10¹⁵˜ 1×10¹⁸ cm⁻³. The guard ring 110 may improve the breakdown characteristics of the single photon detection device 73. Specifically, the guard ring 110 may alleviate the concentration of the electric field at the edge of the heavily doped region 108, thereby preventing premature breakdown.

The depletion region R1 may extend along the boundary between the heavily doped region 108 and the first well 104 and the boundary between the heavily doped region 108 and the guard ring 110. For example, the depletion region R1 may be formed along the side surface and bottom surface of the heavily doped region 108. The size of the depletion region R1 may be determined by the doping concentrations of the heavily doped region 108, the guard ring 110, and the first well 104.

A first sub-depletion forming region 132 may be provided on the heavily doped region 108. The first sub-depletion forming region 132 may have a first conductivity type. The doping concentration of the first sub-depletion forming region 132 may be higher than the doping concentration of the first well 104. For example, the doping concentration of the first sub-depletion forming region 132 may be about 1×10¹⁵˜ 1×10²² cm⁻³.

A first sub-depletion region S1 may be formed between the first sub-depletion forming region 132 and the heavily doped region 108. For example, the first sub-depletion region S1 may extend along the boundary between the first sub-depletion forming region 132 and the heavily doped region 108. The first sub-depletion region S1 may reduce or substantially prevent electrons or holes other than electron-hole pairs generated by photons within the single photon detection device 73 from being provided to the depletion region R1. For example, electrons or holes other than electron-hole pairs generated by photons within the single photon detection device 73 may be generated by defects in the surface of the single photon detection device 73 adjacent to the first sub-depletion region S1. The first sub-depletion region S1 may reduce or substantially prevent electrons or holes caused by surface defects of the single photon detection device 73 from moving to the depletion region R1.

An additional contact region 124 may be provided on the side surface of the first sub-depletion forming region 132. The additional contact region 124 may have a second conductivity type. The doping concentration of the additional contact region 124 may be higher than the doping concentration of the heavily doped region 108. For example, the doping concentration of the additional contact region 124 may be about 1×10¹⁵˜ 1×10²² cm⁻³. The additional contact region 124 may be electrically connected to the heavily doped region 108. In exemplary embodiments, a signal may be applied to the heavily doped region 108 through the additional contact region 124. In exemplary embodiments, a signal may be output from the heavily doped region 108 through the additional contact region 124.

The first sub-depletion region S1 of the present disclosure may reduce or substantially prevent electrons or holes generated by surface defects of the single photon detection device 73 from moving to the depletion region R1. Accordingly, a single photon detection device 73 with low noise may be provided.

FIG. 71C is a cross-sectional view corresponding to line J5-J5′ in FIG. 71A. For the sake of brevity, differences from the previously described embodiments may be described.

Referring to FIG. 71C, a single photon detection device 74 may be provided. Unlike what is shown in FIG. 71B, a second sub-depletion forming region 134 may be provided on the opposite side of the second well 120 with respect to the first well 110. The second sub-depletion forming region 134 may be provided on the bottom surface of the first well 102. The second sub-depletion forming region 134 may have a second conductivity type. For example, the doping concentration of the second sub-depletion forming region 134 may be about 1×10¹⁴˜ 1×10²² cm⁻³. In exemplary embodiments, the second sub-depletion forming region 134 may be a part of the substrate region 102.

A second sub-depletion region S2 may be formed between the second sub-depletion forming region 134 and the first well 110. For example, the second sub-depletion region S2 may extend along the boundary between the second sub-depletion forming region 134 and the first well 110. The second sub-depletion region S2 may reduce or substantially prevent electrons or holes other than electron-hole pairs generated by photons within the single photon detection device 74 from being provided to the depletion region R1. For example, electrons or holes other than electron-hole pairs generated by photons within the single photon detection device 74 may be generated by surface defects of the single photon detection device 74 adjacent to the second sub-depletion region S2. The second sub-depletion region S2 may reduce or substantially prevent electrons or holes caused by surface defects of the single photon detection device 74 from moving to the depletion region R1.

The first sub-depletion region S1 and the second sub-depletion region S2 of the present disclosure may reduce or substantially prevent electrons or holes generated by surface defects of the single photon detection device 74 from moving to the depletion region R1. Accordingly, a single photon detection device 74 with low noise may be provided. In exemplary embodiments, it is possible for the single photon detection device 74 to include only the second sub-depletion region S2 without the first sub-depletion region S1.

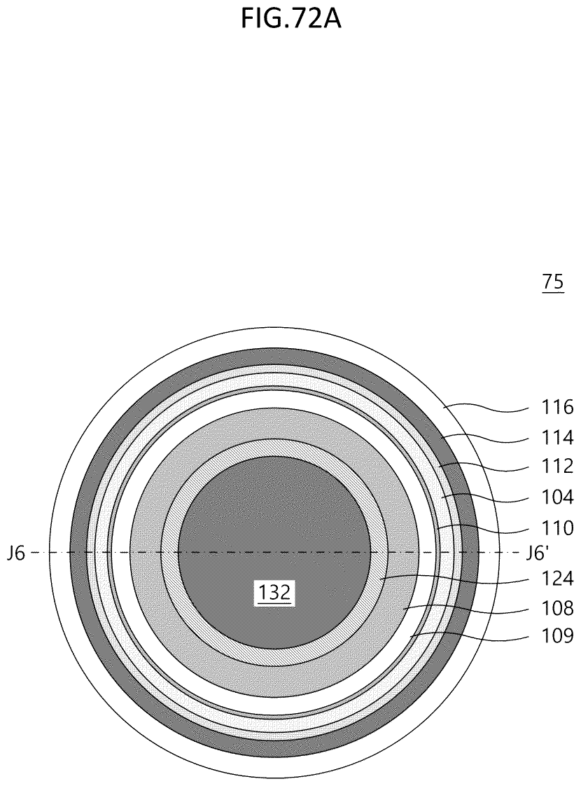

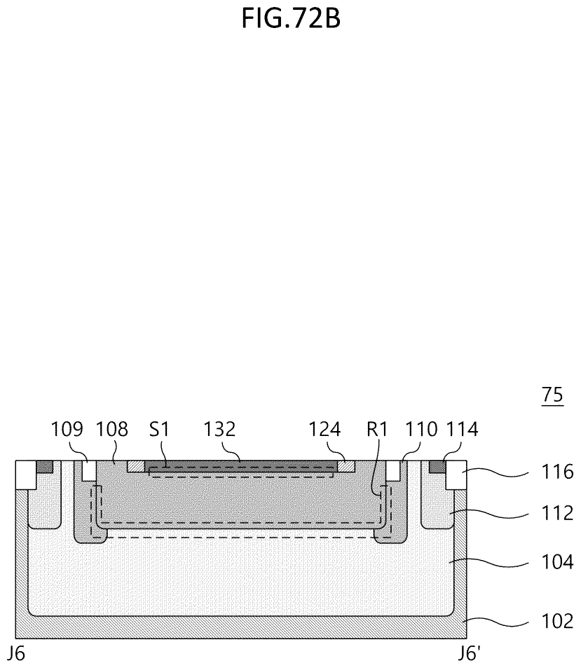

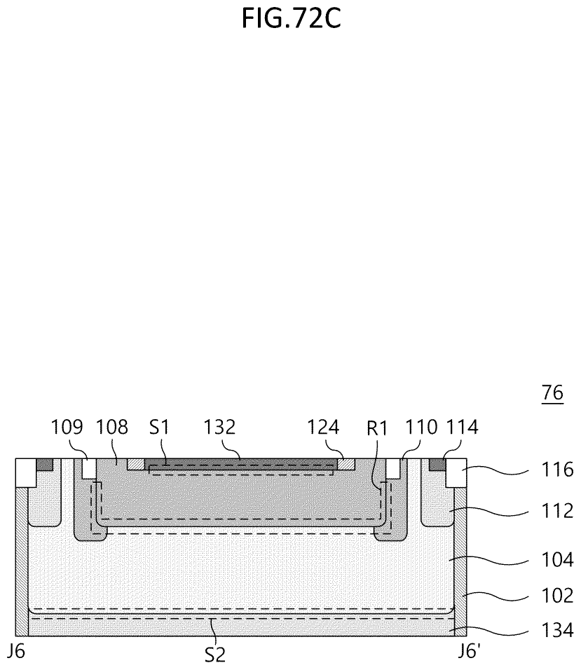

FIG. 72A is a plan view of a single photon detection device according to example embodiments. FIG. 72B is a cross-sectional view taken along line J6-J6′ in FIG. 72A. For the sake of brevity, differences from the previously described embodiments may be described.

Referring to FIGS. 72A and 72B, a single photon detection device 75 may be provided. Unlike what is shown in FIGS. 71A and 71B, the single photon detection device 75 may include an insulating pattern 109. Unlike what is described with reference to FIGS. 50A and 50B, the insulating pattern 109 may be provided between the guard ring 110 and the heavily doped region 108. One side surface and bottom surface of the insulating pattern 109 may contact the guard ring 110. The other side surface of the insulating pattern 109 may contact the heavily doped region 108.

FIG. 72C is a cross-sectional view corresponding to line J6-J6′ in FIG. 72A. For the sake of brevity, differences from the previously described embodiments may be described.

Referring to FIG. 72C, a single photon detection device 76 may be provided. Unlike what is shown in FIG. 71C, the single photon detection device 76 may include an insulating pattern 109. Unlike what is described with reference to FIGS. 50A and 50B, the insulating pattern 109 may be provided between the guard ring 110 and the heavily doped region 108. One side surface and bottom surface of the insulating pattern 109 may contact the guard ring 110. The other side surface of the insulating pattern 109 may contact the heavily doped region 108.

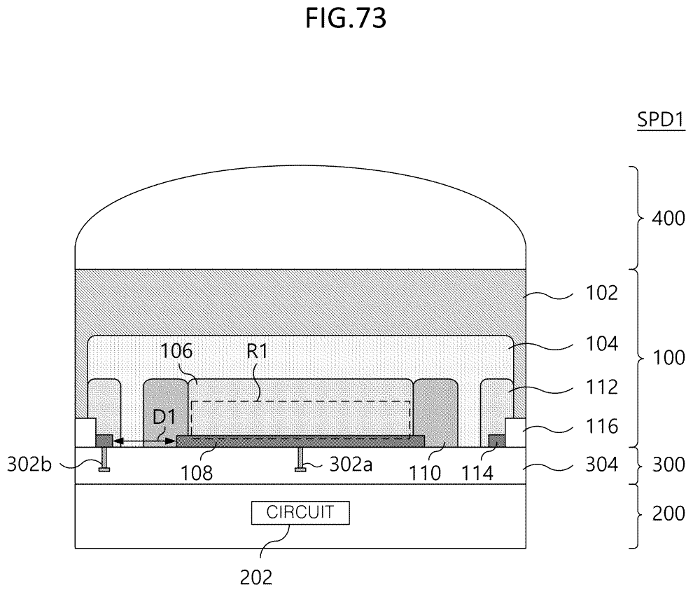

FIG. 73 is a cross-sectional view of a single photon detector according to example embodiments. For conciseness of description, content substantially the same as that described with reference to FIGS. 1 and 2 may not be described.

Referring to FIG. 73, a single photon detector SPD1 may be provided. The single photon detector SPD1 may include a single photon detection device 100, a control layer 200, a connection layer 300, and a lens layer 400. The single photon detector SPD1 may be a Backside Illumination (BSI) type image sensor. The front side may be a surface on which various semiconductor processes are performed when manufacturing the single photon detection device 100, and the back side may be a surface disposed opposite to the front side. For example, the top and bottom surfaces of the single photon detection devices 10 to 74 of the present disclosure may be front and back sides, respectively. The back side illumination method may refer to incident light to the back side of the single photon detection device 100. A front side illumination method described below may refer to light being incident on the front side of the single photon detection device 100. The single photon detection device 100 may be substantially the same as the single photon detection device 10 described with reference to FIGS. 1 and 2. However, this is exemplary. In another example, the single photon detection device 100 may be any one of the single photon detection devices 11 to 74 described above. For convenience of description, the single photon detection device 100 is shown as a reversed top and bottom of the single photon detection device 10 shown in FIG. 2. Accordingly, the top and bottom surfaces of the single photon detection device 100 may be the back and front sides, respectively.

The control layer 200 may be provided on the front side of the single photon detection device 100. Control layer 200 may include circuit 202. For example, the control layer 200 may be a chip on which the circuit 202 is formed. Circuit 202 may include various electronic components as needed. Circuit 202 may include a quenching resistor (or quenching circuit) and a pixel circuit. A quench resistor (or quench circuit) can stop the avalanche effect and allow the single photon avalanche diode (SPAD) to detect another photon. The pixel circuit may include a reset or recharge circuit, a memory, an amplifier circuit, a counter, a gate circuit, a time-to-digital converter, and the like. Circuit 202 may also include DC-to-DC converters and other power management integrated circuits. The circuit 202 may transmit a signal to the single photon detection device 100 or receive a signal from the single photon detection device 100. Although circuit 202 is shown to be provided within control layer 200, this is exemplary. In another example, circuit 202 may be located on a semiconductor substrate on which single photon detection device 100 is formed.

The connection layer 300 may be provided between the single photon detection device 100 and the control layer 200. The connection layer 300 may include an insulating layer 304, a first conductive line 221, and a second conductive line 222. For example, insulating layer 304 may include silicon oxide (eg, SiO₂), silicon nitride (eg, SiN), silicon oxynitride (eg, SiON), or combinations thereof.

The first conductive line 302a and the second conductive line 302b may be electrically connected to the heavily doped region 108 and the contact 114, respectively. The first and second conductive lines 302a and 302b may include an electrically conductive material. For example, the first and second conductive lines 302a and 302b may include copper (Cu), aluminum (Al), tungsten (W), titanium (Ti), titanium nitride (TiN), or a combination thereof. The first and second conductive lines 302a and 302b may include a plurality of portions extending along a direction crossing or parallel to the surface of the single photon detection device 100 facing the connection layer 300. The first and second conductive lines 302a and 302b may electrically connect the heavily doped region 108 and the contact 114 to the circuit 202 of the control layer 200. One of the first conductive line 302a and the second conductive line 302b may apply a bias to the single photon detection device 100, and the other may extract a detection signal. For example, the first conductive line 302a may extract an electrical signal from the heavily doped region 108 and the second conductive line 302b may apply a bias voltage to the contact 114. In another example, the second conductive line 302b may extract an electrical signal from the contact 114 and the first conductive line 302a may apply a bias voltage to the heavily doped region 108.

The lens layer 400 may be provided on the back side of the single photon detection device 100. The lens layer 400 may focus the incident light and transmit it to the single photon detection device 100. For example, the lens layer 400 may include a microlens or a Fresnel lens. In one example, the central axis of the lens layer 400 may be aligned with the central axis of the single photon detection device 100. The central axis of the lens layer 400 and the central axis of the single photon detection device 100 pass through the center of the lens layer 400 and the center of the single photon detection device 100, respectively. The central axis of the lens layer 400 and the central axis of the single photon detection device 100 may be an imaginary axis parallel to the stacking direction of the single photon detection device 100 and the lens layer 400. In one example, the central axis of the lens layer 400 may be misaligned with the central axis of the single photon detection device 100. In one embodiment, at least one optical element may be inserted between the lens layer 400 and the single photon detection device 100. For example, the optical element may be a color filter, a bandpass filter, a metal grid, an anti-reflection coating, a 2D nanomaterial layer, or an organic material layer. In one example, an anti-reflection coating may be formed on top of the lens layer 400.

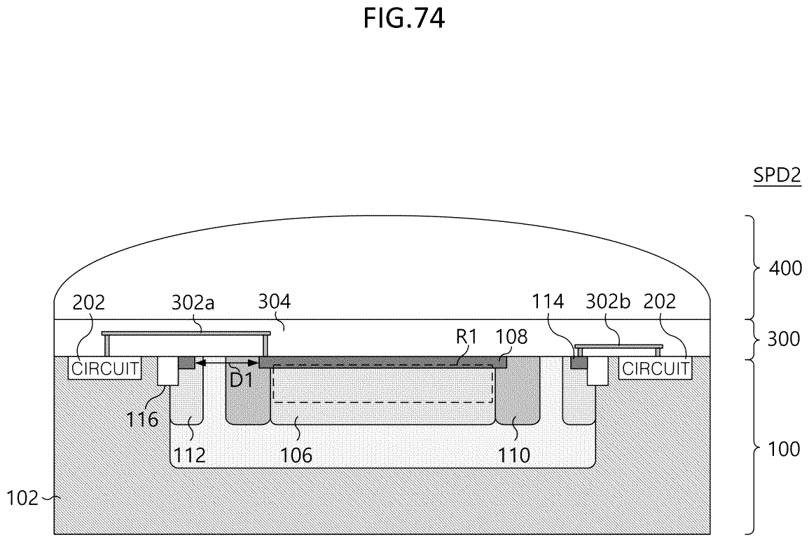

FIG. 74 is a cross-sectional view of a single photon detector according to example embodiments. For brevity of description, content substantially the same as that described with reference to FIG. 73 may not be described.

Referring to FIG. 74, a single photon detector SPD2 may be provided. The single photon detector SPD2 may be a Front Side Illumination (FSI) type image sensor. The single photon detector SPD2 may include a single photon detection device 100, a circuit 202, a connection layer 300, and a lens layer 400. The single photon detection device 100 may be substantially the same as the single photon detection device 100 described with reference to FIG. 73. In example embodiments, the single photon detection device 100 may be any one of the single photon detection devices 11 to 74 described above. For convenience of description, the single photon detection device 100 of the present disclosure is illustrated as a top-down side of the single photon detection device 100 of FIG. 73. Accordingly, the top and bottom surfaces of the single photon detection device 100 may be the front and back sides, respectively.

Circuit 202 may be disposed opposite the contact 114 with the isolation region 116 interposed therebetween. Circuit 202 may be located on top of the substrate region 102. In one example, circuit 202 may be formed on a top surface of the substrate region 102. Circuit 202 may be substantially the same as circuit 202 described with reference to FIG. 73.

The connection layer 300 may be provided on the front side of the single photon detection device 100. The connection layer 300 may include an insulating layer 304, a first conductive line 302a, and a second conductive line 302b. The insulating layer 304, the first conductive line 302a, and the second conductive line 302b may be substantially the same as the insulating layer 304, the first conductive line 302a, and the second conductive line 302b described with reference to FIG. 73, respectively.

A lens layer 400 may be provided on the connection layer 300. Therefore, unlike FIG. 73, the lens layer 400 may be disposed on the front side of the single photon detection device 100. The lens layer 400 may be substantially the same as the lens layer 400 described with reference to FIG. 73. In one embodiment, at least one optical element may be inserted between the lens layer 400 and the connection layer 300. For example, the optical element may be a color filter, a bandpass filter, a metal grid, an anti-reflection coating, a 2D nanomaterial layer, or an organic material layer. In one example, an anti-reflection coating may be formed on top of the lens layer 400.

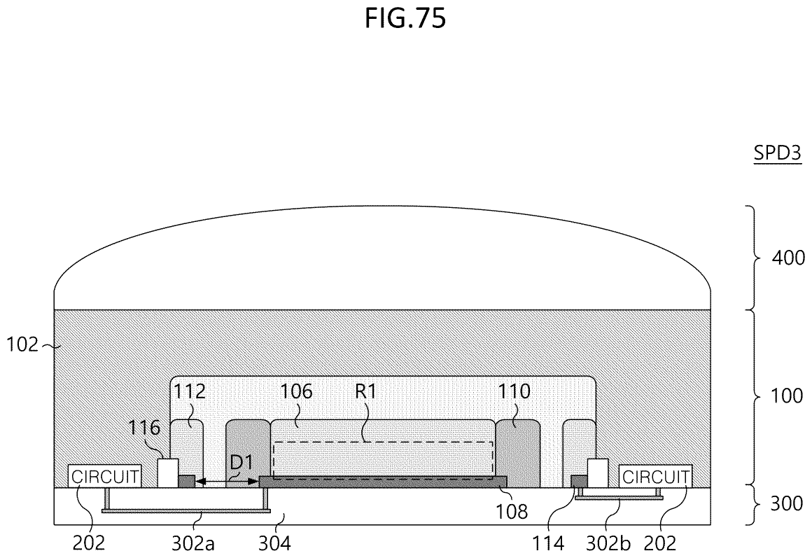

FIG. 75 is a cross-sectional view of a single photon detector according to example embodiments. For brevity of description, content substantially the same as that described with reference to FIG. 73 and with reference to FIG. 74 may not be described.

Referring to FIG. 75, a single photon detector SPD3 may be provided. The single photon detector SPD3 may be a Backside Illumination (BSI) type image sensor. The single photon detector SPD3 may include a single photon detection device 100, a circuit 202, a connection layer 300, and a lens layer 400.

The single photon detection device 100, the circuit 202, and the connection layer 300 are substantially the same as the single photon detection device 100, the circuit 202, and the connection layer 300 described with reference to FIG. 32, respectively. In example embodiments, the single photon detection device 100 may be any one of the single photon detection devices 11 to 74 described above. For convenience of explanation, the single photon detection device 100 is illustrated as the single photon detection device 100 of FIG. 74 upside down. Accordingly, the top and bottom surfaces of the single photon detection device 100 may be the back and front sides, respectively.

As described with reference to FIG. 73, the lens layer 400 may be provided on the back side of the single photon detection device 100. The lens layer 400 may be substantially the same as the lens layer 400 described with reference to FIG. 73. In one embodiment, at least one optical element may be inserted between the lens layer 400 and the single photon detection device 100. For example, the optical element may be a color filter, a bandpass filter, a metal grid, an anti-reflection coating, a 2D nanomaterial layer, or an organic material layer. In one example, an anti-reflection coating may be formed on top of the lens layer 400.

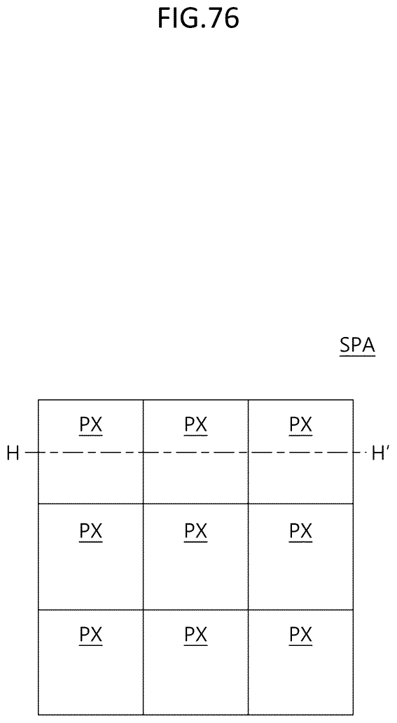

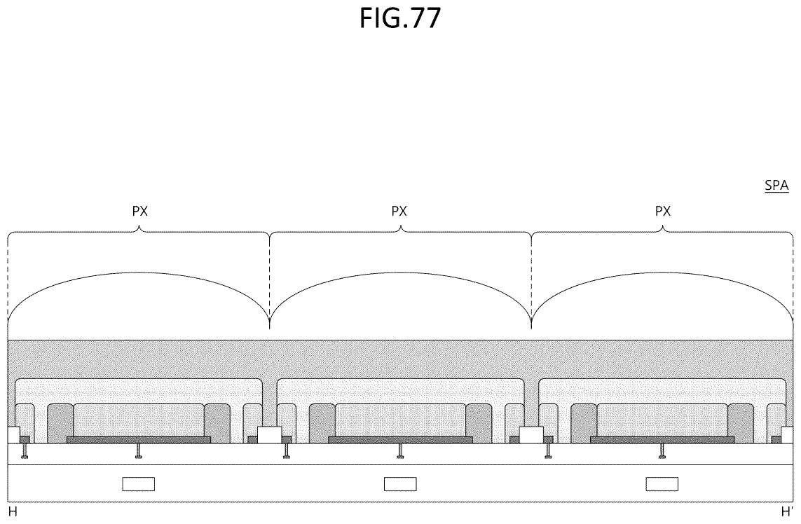

FIG. 76 is a top view of a single photon detector array according to example embodiments. FIGS. 77 to 79 are cross-sectional views taken along line H-H′ of FIG. 76. For brevity of description, content substantially the same as that described with reference to FIG. 73 may not be described.

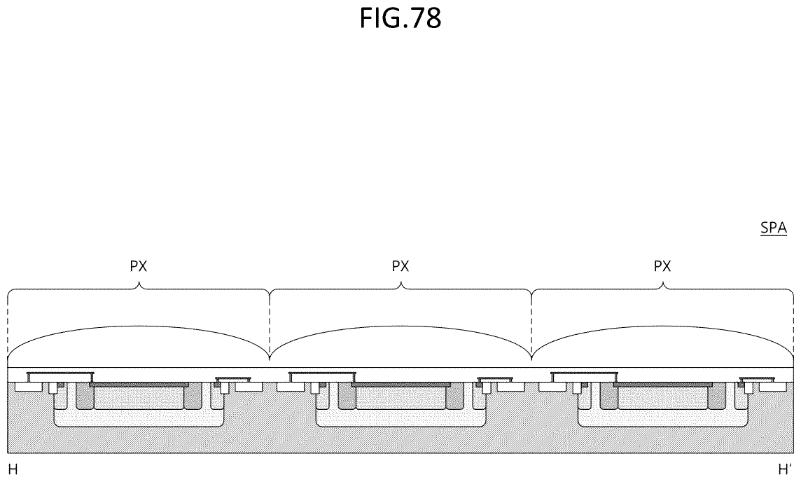

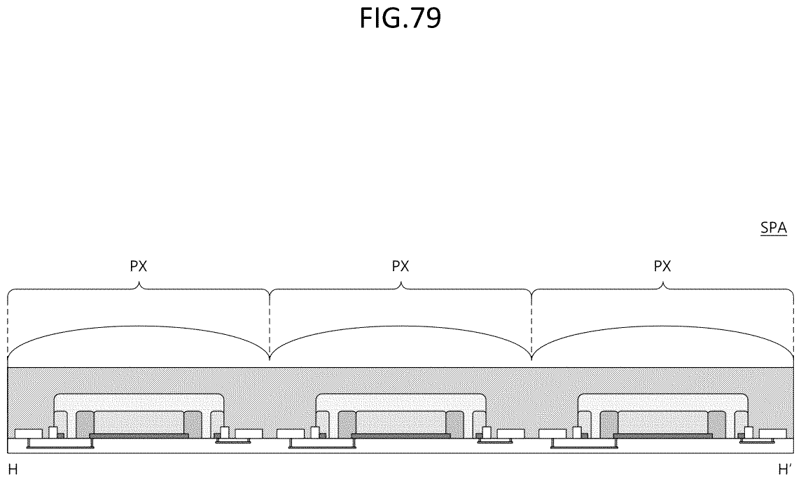

Referring to FIG. 76, a single photon detector array SPA may be provided. The single photon detector array SPA may include pixels PX arranged in two dimensions. Referring to FIG. 77, each of the pixels PX may include the single photon detector SPD1 of FIG. 73 described with reference to FIG. 73. Directly adjacent substrate regions 102 in FIG. 73, directly adjacent isolation regions 116 in FIG. 73, directly adjacent control layers 200 in FIG. 73, directly adjacent connection layers 300 in FIG. 73, and directly adjacent lens layers 400 in FIG. 73 may be connected to each other. Referring to FIG. 78, each of the pixels PX may include the single photon detector SPD2 of FIG. 74 described with reference to FIG. 74. Directly adjacent substrate regions 102 in FIG. 74, directly adjacent connection layers 300 in FIG. 74, and directly adjacent lens layers 400 in FIG. 74 may be connected to each other. Referring to FIG. 79, each of the pixels PX may include the single photon detector SPD3 of FIG. 75 described with reference to FIG. 75. Directly adjacent substrate regions 102 in FIG. 75, directly adjacent connection layers 300 in FIG. 75, and directly adjacent lens layers 400 in FIG. 75 may be connected to each other.

In one example, a separation layer not shown may be provided between the pixels PX. The separation layer can prevent a crosstalk phenomenon in which light incident on a pixel is sensed by another pixel adjacent to the pixel. For example, the separation layer may include silicon oxide, silicon nitride, silicon oxynitride, polycrystalline silicon, a low-k dielectric material, a metal, or combinations thereof. In one example, a metal grid may be provided in a lower region of the lens layer 400 between the pixels PX. For example, the metal grid may include tungsten, copper, aluminum, or combinations thereof.

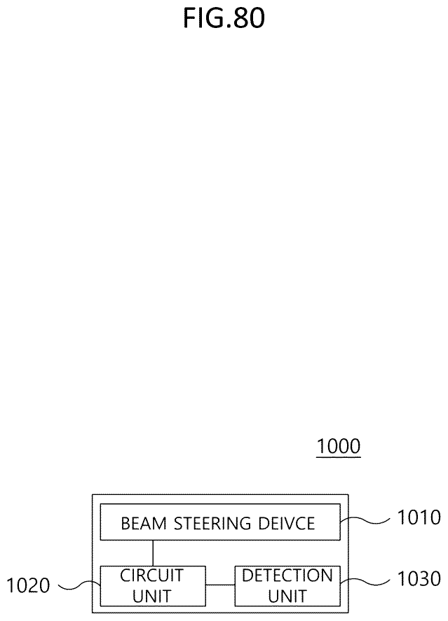

FIG. 80 is a block diagram for describing an electronic device according to example embodiments.

Referring to FIG. 80, an electronic device 1000 may be provided. The electronic device 1000 may radiate light toward a subject (not shown) and detect light reflected by the subject and returned to the electronic device 1000. The electronic device 1000 may include a beam steering device 1010. The beam steering device 1010 may adjust a direction of irradiation of light emitted to the outside of the electronic device 1000. The beam steering device 1010 may be a mechanical or non-mechanical (semiconductor) beam steering device. The electronic device 1000 may include a light source unit within the beam steering device 1010 or may include a light source unit provided separately from the beam steering device 1010. The beam steering device 1010 may be a scanning type light emitting device. However, the light emitting device of the electronic device 1000 is not limited to the beam steering device 1010. In another example, the electronic device 1000 may include a flash type light emitting device instead of the beam steering device 1010 or together with the beam steering device 1010. A flash-type light emitting device may radiate light to an area including an entire field of view at once without a scanning process.

The light steered by the beam steering device 1010 may return to the electronic device 1000 after being reflected by the subject. The electronic device 1000 may include a detector 1030 for detecting light reflected by the subject. The detector 1030 may include a plurality of light detection devices and may further include other optical members. The plurality of light detection devices may include any one of the single photon detection devices 10 to 74 described above. In addition, the electronic device 1000 may further include a circuit unit 1020 connected to at least one of the beam steering device 1010 and the detection unit 1030. The circuit unit 1020 may include a calculation unit that acquires and calculates data, and may further include a driving unit and a control unit. In addition, the circuit unit 1020 may further include a power supply unit and a memory.

Although the case where the electronic device 1000 includes the beam steering device 1010 and the detection unit 1030 in one device is shown, the beam steering device 1010 and the detection unit 1030 are not provided as one device. The beam steering device 1010 and the detection unit 1030 may be provided separately in devices. In addition, the circuit unit 1020 may be connected to the beam steering device 1010 or the detection unit 1030 through wireless communication without being wired.

The electronic device 1000 according to the above-described embodiment may be applied to various electronic devices. As an example, the electronic device 1000 may be applied to a Light Detection And Ranging (LiDAR) device. The LiDAR device may be a phase-shift type device or a time-of-flight (TOF) type device. In addition, the single photon detection devices 10 to 32 according to the embodiment or the electronic device 1000 including the same may be used in smart phones, wearable devices (glasses-type devices realizing augmented reality and virtual reality, etc.), and the Internet of Things (Internet of Things). IoT) devices, home appliances, tablet PCs (personal computers), PDAs (personal digital assistants), PMPs (portable multimedia players), navigation, drones, robots, unmanned vehicles, self-driving cars, and Advanced Drivers Assistance System (ADAS).

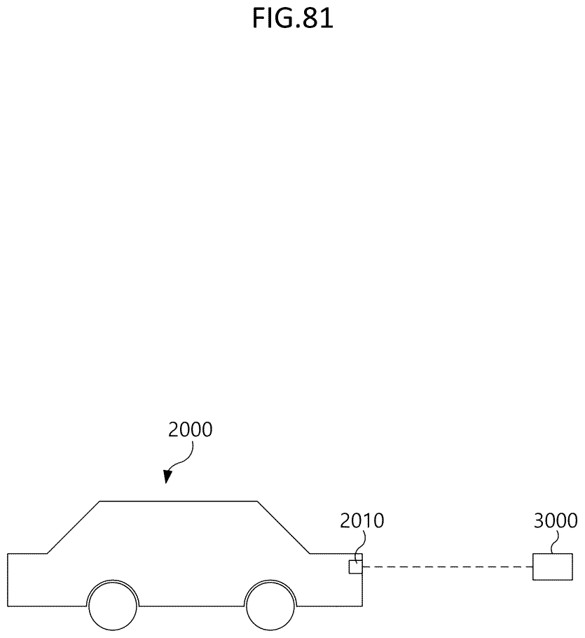

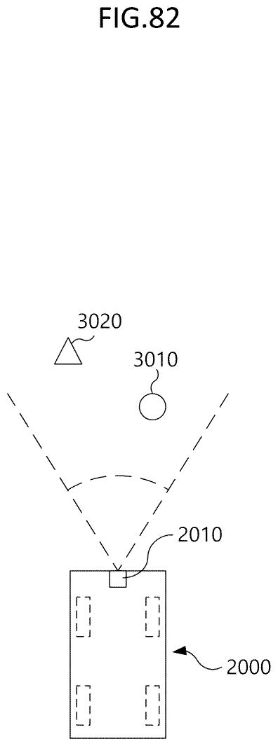

FIGS. 81 and 82 are conceptual diagrams showing the application of a LiDAR device to a vehicle according to example embodiments.

Referring to FIGS. 81 and 82, a LiDAR device 2010 may be applied to a vehicle 2000. Information on the subject 3000 may be obtained using a LiDAR device 2010 applied to a vehicle. The vehicle 2000 may be an automobile having an autonomous driving function. The LiDAR device 2010 may detect an object or person, ie, the subject 3000, in the direction in which the vehicle 2000 travels. The LiDAR device 2010 may measure the distance to the subject 3000 using information such as a time difference between a transmission signal and a detection signal. The LiDAR device 2010 may obtain information about a near subject 3010 and a far subject 3020 within a scanning range. The LiDAR device 2010 may include the electronic device 1000 described with reference to FIG. 80. It is illustrated that a LiDAR device 2010 is disposed in front of the vehicle 2000 to detect the subject 3000 in the direction in which the vehicle 2000 is traveling, but this is not limiting. In another example, the LiDAR device 2010 may be disposed at a plurality of locations on the vehicle 2000 to detect all subjects 3000 around the vehicle 2000. For example, four LiDAR devices 2010 may be disposed at the front, rear, and both sides of the vehicle 2000, respectively. In another example, the LiDAR device 2010 is disposed on the roof of the vehicle 2000 and rotates to detect all subjects 3000 around the vehicle 2000.

The above description of embodiments of the technical idea of the present disclosure provides examples for explanation of the technical idea of the present disclosure. Therefore, the technical spirit of the present disclosure is not limited to the above embodiments, and it is clear that many modifications and changes, such as combining and implementing the above embodiments, are possible by those skilled in the art within the technical spirit of the present disclosure.

What is claimed is:

1. A single photon detection device comprising:
a guard ring having a first conductivity type;
a heavily doped region provided in an inner region surrounded by the guard ring and having a second conductivity type different from the first conductivity type;
a contact provided on an opposite side of the heavily doped region with respect to the guard ring and spaced apart from the guard ring; and
a depletion region formed on a side surface and a bottom surface of the heavily doped region.

2. The single photon detection device of claim 1, further comprising:
a first well provided on the bottom surface of the heavily doped region and having the first conductivity type,
wherein the first well extends to a region vertically overlapping with the guard ring and the contact region.

3. The single photon detection device of claim 2, wherein the depletion region extends along a boundary between the heavily doped region and the guard ring and a boundary between the heavily doped region and the first well.

4. The single photon detection device of claim 2, further comprising:
a second well provided between the heavily doped region and the first well and having the first conductivity type,
wherein the depletion region extends along a boundary between the heavily doped region and the guard ring and a boundary between the heavily doped region and the second well.

5. The single photon detection device of claim 4, wherein the guard ring extends to a depth deeper than the second well.

6. The single photon detection device of claim 5, wherein the guard ring extends to a depth deeper than the second well.

7. The single photon detection device of claim 4, wherein the second well extends to a depth deeper than the guard ring.

8. The single photon detection device of claim 4, wherein a side surface of the heavily doped region and a side surface of the second well are vertically aligned.

9. The single photon detection device of claim 2, further comprising:
a third well provided between the heavily doped region and the first well and having the second conductivity type,
wherein the depletion region extends along a boundary between the third well and the guard ring and a boundary between the third well and the first well.

10. The single photon detection device of claim 9, wherein the third well extends between the heavily doped region and the guard ring to cover the side surface of the heavily doped region.

11. The single photon detection device of claim 2, further comprising:
a first sub-depletion forming region provided on an opposite side of the first well with respect to the heavily doped region and having the first conductivity type; and
a first sub-depletion region provided between the heavily doped region and the first sub-depletion forming region.

12. The single photon detection device of claim 2, further comprising:
a second sub-depletion forming region provided on an opposite side of the heavily doped region with respect to the first well and having the second conductivity type; and
a second sub-depletion region provided between the first well and the second sub-depletion forming region.

13. The single photon detection device of claim 1, further comprising:
a relief region provided on a bottom surface of the contact region and having the first conductivity type,
wherein a doping concentration of the relief region is lower than a doping concentration of the contact region.

14. The single photon detection device of claim 13, further comprising:
a first well provided on the bottom surface of the heavily doped region and having the first conductivity type,
wherein the first well extends between the guard ring and the relaxation region.

15. The single photon detection device of claim 13, wherein the relaxation region is in contact with the guard ring.

16. The single photon detection device of claim 13,
wherein a side surface of the contact region and a side surface of the relief region form a coplanar surface.

17. The single photon detection device of claim 1, further comprising:
an insulating pattern provided on a side surface of the heavily doped region and in contact with the guard ring.

18. The single photon detection device of claim 17, further comprising:
a third well provided between the heavily doped region and the first well, extending between the heavily doped region and the guard ring, and having the second conductivity type, wherein the insulating pattern is in contact with the third well.

19. A single photon detector comprising a single photon detection device, a connection layer, and a lens layer that delivers incident light to the single photon detection device,
wherein the single photon detection device comprises:
a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.

20. An electronic device comprising a light emitting device and a single photon detection device detecting incident light reflected from an object upon which light emitted from the light emitting device is incident, the electronic device measuring a distance to the object using time difference information between a transmission signal of the light emitting device and a detection signal of the single photon detection device,
wherein the single photon detection device comprises:
a guard ring having a first conductivity type, a heavily doped region provided in an inner region surrounded by the guard ring and having a second conductivity type different from the first conductivity type, a contact provided on an opposite side of the heavily doped region with respect to the guard ring and spaced apart from the guard ring, and a depletion region formed on a side surface and a bottom surface of the heavily doped region.
